(19) United States
(12) Patent Application Publication
(10) Pub. No.: US 2026/0288801 A1
(43) Pub. Date: Sep. 24, 2026

(54) SYSTEM

(71) Applicant: SoftBank Group Corp., Tokyo (JP)

(72) Inventor: Kazuhiro HATAKEDA, Tokyo (JP)

(73) Assignee: SoftBank Group Corp., Tokyo (JP)

(21) Appl. No.: 19/562,767

(22) Filed: Mar. 11, 2026

(30) Foreign Application Priority Data
Mar. 19, 2025 (JP) 2025-044466

(51) Int. Cl. G06F 16/3329; G06Q 10/101

(52) U.S. Cl. CPC G06F 16/33295; G06Q 10/101

(57) ABSTRACT

A system includes a processor that is configured to receive input information from a user and generate a prompt sentence for instructing a generative AI model to perform a specific operation, input the generated prompt sentence into the generative AI model to generate one or more personas, and analyze the generated one or more personas and utilize a result of the analysis for product development.

### CROSS-REFERENCE TO RELATED APPLICATION

This application is based on and claims priority under 35 USC 119 from Japanese Patent Application No. 2025-044466 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional product development processes rely heavily on market research methods such as questionnaires, interviews, and focus groups. These methods are time-consuming, costly, and often limited in both depth and breadth of insight, particularly when a development team needs to rapidly explore diverse user viewpoints or simulate reactions from various types of target customers. Furthermore, it is difficult for conventional methods to dynamically generate and update user personas in response to evolving product concepts and development stages. As a result, product development teams frequently lack timely, multifaceted, and scenario-specific feedback that could improve product planning and refinement. The invention has been made in view of these circumstances, and an object of the invention is to provide a system that uses a processor to instruct a generative AI model, automatically generate and analyze personas based on user input information, and utilize persona-based opinions throughout multiple stages of product development, thereby enabling low-cost, rapid, and diverse insight generation that supplements or partially replaces conventional market research.

### SUMMARY

To solve the above-described problems, the invention provides a system comprising a processor, wherein the processor is configured to receive input information from a user and generate a prompt sentence for instructing a generative AI model to perform a specific operation, input the generated prompt sentence into the generative AI model to generate one or more personas, and analyze the generated one or more personas and utilize a result of the analysis for product development. In one aspect, the processor is configured to analyze the input information from the user, such as age range, thinking tendencies, and hobbies, and generate the prompt sentence based on a result of the analysis, thereby enabling automatic creation of diverse and context-appropriate personas. In another aspect, the processor is configured to collect opinions of the generated one or more personas for providing opinions at each stage of product development, and provide the collected opinions to a product development team, so that persona-based feedback can be systematically applied to idea generation, concept refinement, detailed design, and prototype evaluation. Through these configurations, the system enables efficient and iterative utilization of AI-generated personas and their opinions, thereby achieving more comprehensive and timely support for product development activities.

The term “system” refers to an arrangement of one or more hardware and software components including at least one processor configured to execute the functions described in the present specification and claims.

The term “processor” refers to any hardware device or combination of hardware devices that executes instructions, including but not limited to a CPU, GPU, ASIC, FPGA, microcontroller, or a plurality of such devices operating together.

The term “user” refers to a human operator, a group of human operators, or an external system acting on behalf of a human operator, who provides input information to the system and utilizes outputs of the system.

The term “input information” refers to information provided by the user to the system, including but not limited to demographic attributes, preferences, behavioral tendencies, product-related requirements, and any other data used by the processor to generate a prompt sentence.

The term “prompt sentence” refers to textual data generated by the processor and supplied to a generative AI model, the textual data specifying instructions, conditions, or context for causing the generative AI model to perform a specific operation such as persona generation or opinion generation.

The term “generative AI model” refers to a machine learning model configured to generate text, images, or other content based on input data, and includes, for example, a large language model or any other model capable of generating persona descriptions and opinions in response to a prompt sentence.

The term “persona” refers to a synthesized representation of a hypothetical or archetypal user, including attributes such as demographic characteristics, preferences, behaviors, values, and opinions, which is generated by the generative AI model based on the prompt sentence.

The term “analyze” or “analysis” refers to a process performed by the processor to interpret, classify, extract features from, summarize, or otherwise process the generated one or more personas or their opinions, in order to derive information usable for product development.

The term “product development” refers to a series of activities related to planning, designing, implementing, testing, and refining a product or service, including but not limited to idea generation, concept formulation, detailed design, prototyping, and pre-launch evaluation.

The term “opinion” refers to a comment, evaluation, impression, preference, concern, suggestion, or other subjective statement attributed to a persona with respect to a product, product concept, feature, or use case.

The term “product development team” refers to one or more human participants involved in product development activities, including but not limited to planners, designers, engineers, marketers, and managers, who receive and utilize the persona-based opinions provided by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

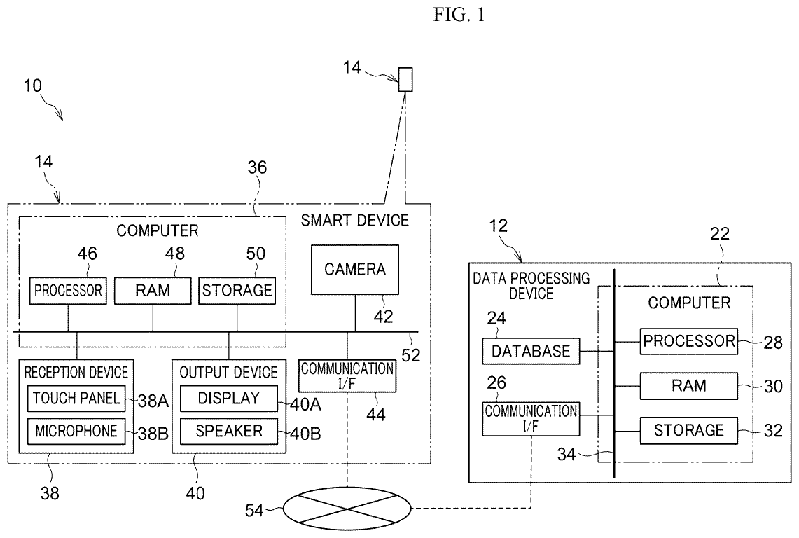

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

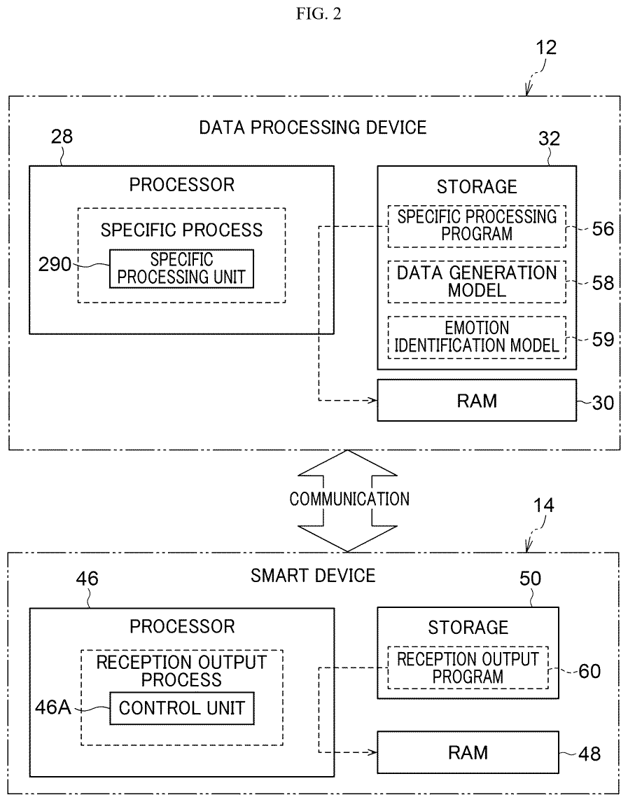

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented techniques for utilizing personas in product or service development suffer from several technical limitations in how information is generated, structured, and delivered within an information processing system. In many existing systems, persona descriptions are either manually authored or generated in an ad hoc manner, resulting in unstructured text that is not aligned with machine-processed input conditions, and that does not support efficient reuse or systematic querying by downstream applications. As a result, a server often handles persona information as opaque free text that cannot be reliably linked back to the original user input, cannot be programmatically decomposed into background, values, behavioral characteristics, and purchasing behavior, and cannot be dynamically extended for context-specific evaluations of product specifications, functions, or pricing.

Furthermore, in such conventional systems, prompt information supplied to a generative AI model is often composed manually or by simple concatenation at the client side, without robust server-side validation, completion, or normalization. This can lead to ambiguous or inconsistent prompts, which in turn cause the generative AI model to produce unstable persona outputs that vary significantly in structure and relevance. From a computer-technology standpoint, this ambiguity increases processing overhead on the server and client, complicates storage and indexing of generated text, and makes it difficult to build reliable server-side workflows that consume persona data as structured resources.

Additionally, existing architectures typically do not provide a unified server-controlled loop in which: (i) user attribute information is collected via a user terminal, (ii) the server normalizes and completes missing or inconsistent fields, (iii) the server automatically constructs a standardized prompt sentence for a generative AI model, (iv) the server receives persona text and transforms it into structured categories suitable for storage and retrieval, and (v) the server subsequently generates follow-up prompts referencing the stored persona to obtain evaluation content for different stages of product development. In the absence of such an integrated pipeline, the server cannot efficiently orchestrate persona generation, storage, and re-querying, which leads to excessive manual intervention, fragmented data flows, and increased latency and resource consumption across the system.

Accordingly, there is a need for an improved computer-implemented system and server that: (1) automatically converts heterogeneous user input information into normalized and completed attribute information; (2) generates a standardized prompt sentence that clearly specifies persona generation conditions for a generative AI model; (3) receives and structurally organizes persona information into predefined categories suitable for machine processing and storage; and (4) generates additional prompt sentences that query the generative AI model for evaluation content regarding product or service proposals at various stages of product development. By addressing these technical issues, the overall efficiency, reliability, and reusability of persona-based processing within the information processing system can be improved, thereby enhancing the technical operation of the server and its interaction with the generative AI model and user terminals.

The specific processing by the specific processing unit 290 of the data processing device 12 in Example 1 is realized by the following means.

The present invention provides a server comprising a processor and a communication interface, the processor being configured to receive, via the communication interface, input information including attribute information comprising at least an age range, a thinking tendency, and a preference from a user terminal; analyze the received input information, detect a missing item or an inconsistent item in the received input information, and perform completion or correction of the missing item or the inconsistent item based on predefined attribute candidates so as to obtain normalized attribute information; construct, by applying the normalized attribute information to a natural language template, a prompt sentence as instruction information that directs a generative AI model to generate persona information, the prompt sentence being included in generation request data; transmit, via the communication interface, the generation request data including the prompt sentence to the generative AI model disposed externally or internally to the server, and obtain, from the generative AI model, text data as persona information generated by natural language processing performed by the generative AI model based on the prompt sentence; classify the obtained persona information in accordance with a usage mode for planning, designing, or evaluating a product or a service, and organize the persona information into background information, values information, behavioral characteristic information, and purchasing behavior information; store the organized persona information in a storage unit in association with the normalized attribute information; generate additional prompt sentences based on at least a part of the organized persona information, the additional prompt sentences inquiring evaluation content with respect to specification proposals, function proposals, or price proposals of the product or the service; transmit, via the communication interface, additional input data including the additional prompt sentences to the generative AI model, obtain, from the generative AI model, the evaluation content generated based on the additional prompt sentences, and classify and provide the evaluation content to a product development team in association with respective examination stages of product development by generating response data including the persona information and the evaluation content and transmitting the response data to the user terminal operated by a product development operator. This enables the server to perform a unified, computer-implemented workflow that reliably normalizes user attribute inputs, generates clear and structured prompt sentences for a generative AI model, converts unstructured persona outputs into categorized and storable data, and iteratively queries the generative AI model for stage-specific evaluation content, thereby improving the efficiency, consistency, and technical robustness of persona-based processing in the information processing system.

The term “system” refers to a combination of one or more hardware devices and one or more software components that cooperate to perform information processing, including at least a processor and a communication interface.

The term “processor” refers to one or more hardware processing units, such as a central processing unit or a graphics processing unit, and associated control circuitry configured to execute instructions of a program.

The term “communication interface” refers to hardware and software components that enable data transmission and reception between the server and external devices or services over a wired or wireless communication network.

The term “user terminal” refers to an information processing apparatus operated by a user, such as a personal computer, a mobile device, or an embedded device, that communicates with the server via the communication interface.

The term “input information” refers to information transmitted from the user terminal to the server, including attribute information representing characteristics of a target user or persona to be generated.

The term “attribute information” refers to information that characterizes a user or persona in terms of demographic, cognitive, and preference-related aspects, including at least an age range, a thinking tendency, and a preference.

The term “age range” refers to information indicating a span of ages, expressed in a grouped or categorical form, such as teens, twenties, thirties, or similar ranges.

The term “thinking tendency” refers to information indicating a predominant cognitive style or attitude, such as innovative, cautious, analytical, or pragmatic, associated with a user or persona.

The term “preference” refers to information indicating likes, interests, or favored activities or items of a user or persona, such as hobbies, favored product categories, or usage tendencies.

The term “normalized attribute information” refers to attribute information that has been converted, completed, and corrected according to predefined rules or candidates so that the information conforms to a standardized internal representation.

The term “predefined attribute candidates” refers to predetermined values or categories of attribute information stored in the system and used as references for completing or correcting missing or inconsistent items in the received input information.

The term “prompt sentence” refers to a natural language instruction string constructed by the server and supplied to the generative AI model to specify conditions and requirements for generating persona information or evaluation content.

The term “instruction information” refers to data, including at least one prompt sentence, that defines how the generative AI model is to operate or what content the generative AI model is to generate.

The term “natural language template” refers to a parameterized text pattern in a natural language into which attribute information is inserted or bound to produce a complete prompt sentence.

The term “generation request data” refers to data transmitted from the server to the generative AI model, including at least one prompt sentence and optionally model parameters and control settings for text generation.

The term “generative AI model” refers to a computer-implemented model, such as a neural network-based language model, that generates text data based on input prompt sentences by performing natural language processing.

The term “persona information” refers to text data generated by the generative AI model that describes a fictitious or abstract user profile, including background, values, behavior, and purchasing tendencies.

The term “text data” refers to information represented as a sequence of characters or tokens in a natural language, including sentences, paragraphs, or structured textual descriptions.

The term “natural language processing” refers to computational techniques and algorithms that analyze and generate human language text, including tokenization, probability-based prediction, and output sequence generation.

The term “usage mode” refers to a manner or context in which persona information is used within the system, including but not limited to planning, designing, and evaluating a product or a service.

The term “background information” refers to a part of the persona information describing demographic and contextual aspects, such as occupation, living environment, education, and general lifestyle.

The term “values information” refers to a part of the persona information describing beliefs, priorities, motivations, and criteria that influence decisions and evaluations of the persona.

The term “behavioral characteristic information” refers to a part of the persona information describing typical actions, habits, decision-making patterns, and interaction tendencies of the persona.

The term “purchasing behavior information” refers to a part of the persona information describing patterns and tendencies related to acquisition of goods or services, including decision criteria, frequency, and preferred channels.

The term “storage unit” refers to one or more storage devices, such as semiconductor memory or magnetic storage, and associated management software configured to store persona information, attribute information, and related metadata.

The term “additional prompt sentences” refers to prompt sentences generated by the server after initial persona generation, which request further information or evaluation content from the generative AI model based on existing persona information.

The term “additional input data” refers to data transmitted from the server to the generative AI model after initial persona generation, including additional prompt sentences and optional parameters for obtaining further output.

The term “evaluation content” refers to text data generated by the generative AI model in response to additional prompt sentences, describing assessments, opinions, or reactions of the persona to product or service proposals.

The term “specification proposals” refers to proposals describing technical or functional specifications of a product or a service, including feature sets, performance characteristics, and design options.

The term “function proposals” refers to proposals describing individual functions or capabilities to be provided by a product or a service.

The term “price proposals” refers to proposals describing pricing schemes, fee structures, or monetary conditions for offering a product or a service.

The term “product development team” refers to a group of operators or stakeholders who are involved in planning, designing, or evaluating products or services using the persona information and evaluation content provided by the system.

The term “examination stages of product development” refers to different phases within a product or service development process, including concept planning, design, prototyping, testing, and pre-launch evaluation.

The term “response data” refers to data generated by the server and transmitted to the user terminal, including at least a part of the persona information and evaluation content, and optionally associated metadata for display and use.

The term “product development operator” refers to a user who operates the user terminal to view, analyze, and utilize persona information and evaluation content in connection with product or service development activities.

In one embodiment, the server implements the claimed system by executing a server program on an information processing apparatus comprising at least one central processing unit (CPU), one or more hardware accelerators such as graphics processing units (GPUs), a main memory, a non-volatile storage device, and a network interface. The server runs an operating system such as a general-purpose server operating system, and one or more middleware components such as a web server and an application framework. The server executes machine-readable instructions that cause the server to perform input acquisition, attribute normalization, prompt sentence generation, communication with a generative AI model, persona information structuring, storage management, and generation of additional prompt sentences for evaluation.

The server uses a web server software component, for example software of the type commonly used to terminate HTTPS connections, to receive requests from the terminal. The server uses an application framework, for example a framework of the type that provides routing and request parsing in a high-level language, to implement application logic. The server uses a database management system, for example a relational database system or a document-oriented database system, to store normalized attribute information, prompt sentences, persona information, and evaluation content in structured form.

The terminal is an information processing apparatus such as a personal computer, a smartphone, or a tablet device including at least one CPU, a memory, a display, and an input device such as a keyboard, pointing device, or touch screen. The terminal runs a client application such as a web browser or native application. The terminal transmits user input information to the server and displays persona information and evaluation content received from the server.

The user operates the terminal to open a persona generation screen provided by the server. The terminal displays input fields for attribute information, including an age range (for example, “30s”), a thinking tendency (for example, “innovative”), and preferences (for example, “music”). The terminal may additionally display selectable lists that correspond to predefined attribute candidates held by the server, so that the user is encouraged to choose values that map directly to server-side representations. The user enters or selects the attribute information, and the terminal transmits the attribute information to the server via the network interface using a structured data format.

The server receives the attribute information and converts the attribute information into normalized attribute information. The server maintains, in the storage device, a table or other data structure that maps free-form user entries to internal standardized categories. For example, if the user inputs “innovative thinker” the server maps this to a canonical internal value “innovative,” and if the user inputs “loves listening to live bands” the server maps this to a canonical preference category “music.” The server also stores, as predefined attribute candidates, age ranges such as “teens,” “20s,” “30s,” and so on, and preference categories such as “music,” “sports,” or “reading.”

The server checks each received attribute item against the predefined attribute candidates. When the server detects a missing item, the server supplements the item by applying rule-based logic that uses correlations between existing attributes and statistical distributions stored from past usage. When the server detects an inconsistent item, the server performs correction by aligning the item with the closest candidate using a similarity measure such as an edit distance or vector similarity computed over an embedding of the input string. By performing this normalization and completion on the server side, the server reduces ambiguity and enforces that downstream components, including the generative AI model, receive consistently structured prompts. This processing improves internal data quality, reduces error cases, and enhances reproducibility of outputs across repeated invocations.

After normalization, the server constructs a prompt sentence in natural language. The server maintains a natural language template stored as a template record in the database or in a configuration file. The template includes slots for age range, thinking tendency, and preferences, as well as additional descriptive items. The server replaces the slots with normalized attribute information using a template engine. For example, when the normalized attribute information indicates that the persona is in the 30s, has an innovative thinking tendency, and enjoys music, the server generates a prompt sentence such as:

“You are a generative AI model that creates detailed personas. Please generate a persona who is in their thirties, has an innovative thinking style, and enjoys music as a hobby. Describe their background, daily routine, values, technology usage, and how they evaluate new consumer products, especially audio devices and music-related services.”

In another example, when the normalized attribute information indicates that the persona is a cautious and analytical reader in their twenties, the server generates a prompt sentence such as:

“Please generate a persona who is a female in her twenties, has a cautious and analytical thinking style, and enjoys reading mystery novels. Describe her lifestyle, values, and how she chooses new consumer electronics products.”

The server then communicates with a generative AI model. In one embodiment, the generative AI model is a transformer-based neural network that has been pre-trained on large-scale text data and fine-tuned on instruction-following tasks. The model architecture includes an embedding layer for mapping tokens to vector representations, multiple self-attention layers for modeling contextual relationships, feed-forward layers, and a final linear layer projecting to vocabulary logits. The model executes on a GPU system under a deep learning framework such as a general-purpose tensor computation framework.

The server sends the prompt sentence, together with parameters such as maximum output length, temperature, and stop conditions, to the generative AI model via an application programming interface. The generative AI model tokenizes the prompt sentence using a predefined subword tokenizer, converts the tokens into embeddings, and applies the transformer layers to compute context-aware hidden states. The model then generates output tokens sequentially using an autoregressive decoding procedure. The decoding procedure can employ sampling methods or beam search to balance diversity and determinism.

During training of the generative AI model, training data pairs of input prompt sentences and desired outputs are used. The model parameters are updated using gradient-based optimization with a loss function such as a cross-entropy loss between predicted and target tokens. The model uses backpropagation through time and an optimizer such as an adaptive learning-rate optimizer. The training process may utilize data augmentation techniques such as prompt paraphrasing or attribute permutations, which enable the model to handle varied natural language formulations of similar conditions. As a result, at inference time, the trained generative AI model can produce persona information with consistent structure even for prompt sentences that exhibit moderate linguistic variation.

By relying on this transformer architecture and training methodology, the generative AI model can capture complex dependencies between the prompt sentence attributes and the generated persona details. This allows the server to obtain persona information that is structurally compatible with the server's downstream parsing and classification operations, without requiring manual authoring or rule-based expansion of persona details. The use of deep neural network inference on GPU hardware also enables the server to generate rich persona descriptions with lower latency compared to naive template expansion or purely manual techniques.

The server receives the generated persona text from the generative AI model and transforms the persona text into structured persona information. The server applies a combination of pattern-based extraction and a lightweight classifier to assign segments of the persona text into categories, such as background information, values information, behavioral characteristic information, and purchasing behavior information. In one variant, the server uses section marker tokens embedded in the prompt sentence (for example, asking the model to label sections with headings such as “Background:”, “Values:”, “Behavior:”, and “Purchasing behavior:”) so that the persona text naturally separates into those categories. In another variant, the server uses a text classification model or rule-based parsing to detect sentences corresponding to each category.

The server stores the structured persona information in a database using a schema that associates each persona with normalized attribute information, one or more generated prompt sentences, and category-specific fields. For example, the database stores a persona record with fields such as “age_range,” “thinking_tendency,” “preference,” “background_text,” “values_text,” “behavior_text,” and “purchasing_behavior_text.” By storing persona information in this structured form, the server enables efficient querying, indexing, and reuse of persona components. This structured storage improves data management, reduces duplication, and makes it possible to generate further prompt sentences that reference specific sections of a persona.

The server subsequently generates additional prompt sentences to obtain evaluation content regarding product or service proposals. For example, after storing a persona, the server constructs an additional prompt sentence such as:

“Based on the previously generated persona (30s, innovative thinking, music hobby), explain how this persona would react to a new premium music streaming subscription that offers higher audio quality and exclusive live session recordings. Describe their concerns, motivations, and likelihood of subscription.”

In another example, the server generates an additional prompt sentence such as: “Based on the persona who is a cautious and analytical mystery novel reader in her twenties, evaluate a new e-reader device that has a high-resolution screen, adjustable warm light, and a subscription model for unlimited mystery titles. Describe her perceived advantages, concerns, and purchase decision process.”

The server sends these additional prompt sentences to the generative AI model and obtains evaluation content that assesses specification proposals, function proposals, or price proposals. The server then classifies the evaluation content by examination stages of product development, such as “concept evaluation,” “feature refinement,” or “pricing validation,” and associates the evaluation content with corresponding persona records in the database.

By performing normalization of attribute information, standardized prompt construction, structured persona parsing, and stage-specific evaluation query within the server, the system achieves technical advantages beyond mere automation of human activities. The server reduces ambiguity and variability in input data by enforcing normalization and completing missing values based on predefined attribute candidates. This allows the server to reduce the number of malformed prompts and error responses from the generative AI model, thereby improving overall processing speed and reliability. The server further improves data management by structuring persona information into specific categories and storing these categories with explicit links to attributes and evaluation stages, which enables efficient retrieval and re-use of persona segments in subsequent computations.

The server also reduces communication load by sending compact, normalized attributes and concise prompt sentences, instead of repeatedly transmitting large volumes of raw human-authored persona descriptions between the terminal and the server. Because the server centralizes prompt generation and persona structuring, the terminal can remain thin and transmit only attribute selections and display instructions, while the server orchestrates heavy computation on GPU hardware and database systems. This division of labor optimizes resource utilization and reduces latency visible to the user.

From a technical standpoint, the system improves computer technology in several ways. First, the system introduces a non-conventional server-side pipeline that links normalized attribute information to standardized prompt sentences and structured persona storage, thereby enabling the machine to treat persona information as a structured, queryable resource rather than opaque text. Second, the system exploits specific properties of transformer-based generative AI models and training methods to generate persona text in a format that is amenable to automated classification and storage. Third, the system incorporates explicit rule-based and statistical normalization steps that are tailored to persona generation workflows, which materially reduce noise and inconsistencies compared to naive client-side concatenation of attributes.

The server applies specific rules for mapping free-text inputs to canonical attribute categories and for constructing prompt sentences that contain explicit instructions and section headers. These rules are not simply human heuristics; they are engineered to align with the tokenizer and attention mechanisms of the generative AI model, for example by choosing phrasing that produces stable token boundaries and by placing key attribute tokens in positions that are known to have higher attention weights in transformer architectures. This alignment yields higher consistency of persona outputs under the same conditions, thereby reducing variance and improving precision of downstream classification.

The generative AI model, as trained and deployed, processes inputs according to its learned parameters and error function, rather than following human reasoning steps. The training process minimizes a token-level prediction loss over large datasets, and weight updates are computed using gradient descent. Because the decision boundaries in the model are encoded in high-dimensional vector spaces, the generated personas exhibit patterns that would be difficult to obtain solely from handcrafted rule systems. This results in richer and more internally coherent persona information at a given computation time cost, leading to both improved accuracy and faster generation relative to traditional template-based generation for comparable level of detail.

In addition, the system is not limited to a single model deployment. In another embodiment, the server uses multiple generative AI models of different sizes or specialization levels, and dynamically selects a model based on attribute complexity and system load. For example, the server may use a smaller model for simple personas and a larger model for complex personas that require detailed behavioral descriptions. The server can also cache generated personas and evaluation content, so that repeated or similar attribute combinations can be served from storage without requiring fresh model inference. This reduces computation on GPUs and decreases response time, which constitutes an improvement in computational efficiency and energy usage.

In yet another embodiment, the server performs on-device fine-tuning or adapter-based updating of the generative AI model using domain-specific data collected from past persona generations and evaluations. The server uses an additional loss component that penalizes inconsistency between structured categories inferred from persona text and expected category boundaries defined by the system. By updating a subset of model parameters or adapter weights, the server drives the model to generate persona text that better conforms to the system's structured schema. This tight coupling between structured storage and model behavior results in fewer parsing errors, thus directly improving data integrity and reducing the need for costly post-processing.

The terminal, by relying on the server's structured persona and evaluation outputs, can provide advanced user interface features such as section-based navigation, search within persona categories, and comparison of multiple personas for different proposals. However, the terminal does not implement the core normalization, prompt generation, or model inference; these technical tasks remain on the server to ensure consistent application of rules, optimal use of hardware accelerators, and centralized data management.

The user, by interacting with the terminal, benefits from rapid generation and update of personas and evaluation content, but the inventive contribution resides in how the server and generative AI model cooperate to transform loosely specified human attributes into normalized, structured, and technically managed data flows. Through this architecture, the system provides a concrete technical improvement in how computers store, process, and generate persona-related information, achieving increased processing speed, improved accuracy and consistency of generated data, reduced communication overhead, and enhanced manageability of complex, text-based resources in a networked computing environment.

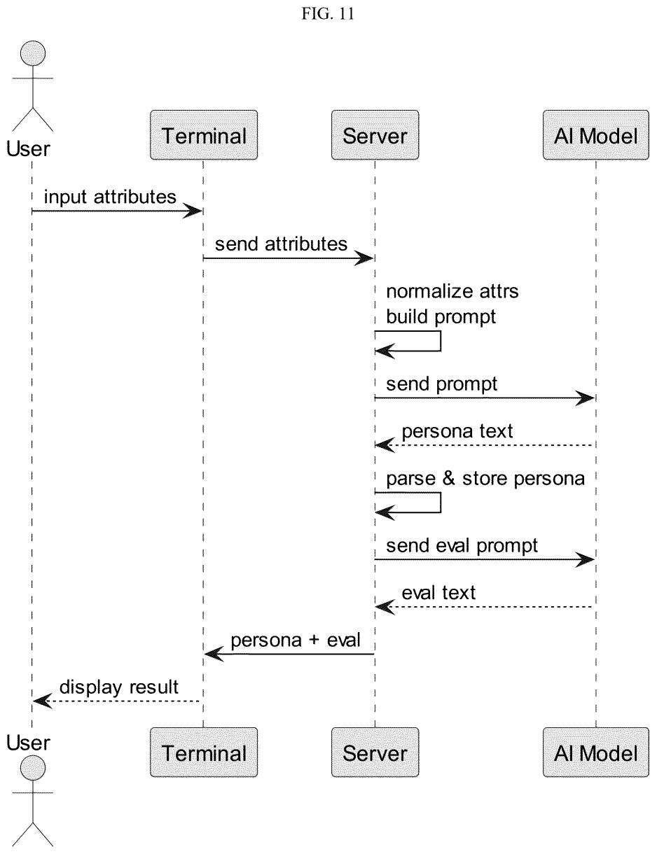

The following describes the processing flow using FIG. 11.

### Step 1

The user operates the terminal to open a persona configuration screen provided by the server.

The terminal receives, as input, a screen definition (HTML, style information, and script) from the server and renders input fields for age range, thinking tendency, and preferences on a display.

The user enters attribute values (for example, “30s”, “innovative”, “music”) using a keyboard or touch operation.

The terminal collects these values as input data, performs client-side checks such as non-empty validation and type checks using a script engine, and converts the values into an internal key-value structure stored in memory.

The terminal outputs a structured attribute object (for example, fields “age_range”, “thinking_tendency”, “preference”) and prepares it for transmission to the server.

### Step 2

The terminal sends the structured attribute object to the server.

The terminal takes, as input, the attribute object created in Step 1 and serializes it into a message body according to a predefined schema.

The terminal attaches metadata such as a session identifier and a timestamp, and transmits the message to the server over a network using a communication protocol stack.

The terminal outputs a network request packet that encapsulates the attribute object and related metadata for processing by the server.

### Step 3

The server receives the request packet containing the attribute object from the terminal.

The server takes the packet as input through a network interface, invokes a web server component to terminate the network protocol, and passes the message body to an application module.

The server parses the message body into a data structure in main memory and confirms that required fields such as age range, thinking tendency, and preference exist.

The server outputs a parsed attribute structure that can be processed by subsequent normalization logic.

### Step 4

The server normalizes and completes the attribute structure.

The server takes the parsed attribute structure as input and accesses a stored mapping table of predefined attribute candidates.

The server performs string matching and similarity computation, such as converting text to a normalized case, applying tokenization, and calculating distances between tokens and candidate terms, to map free-form entries to canonical values.

When the server detects missing entries, the server estimates reasonable defaults by referencing correlations between attributes stored in past persona records or rule definitions, and inserts those defaults into the attribute structure.

The server outputs a normalized attribute record in which all attribute fields conform to canonical categories, reducing ambiguity for downstream processing.

### Step 5

The server generates a prompt sentence based on the normalized attribute record.

The server takes the normalized attribute record as input and loads a natural language template from configuration storage.

The server performs data binding by replacing template slots with the normalized age range, thinking tendency, and preference values, and concatenates fixed text segments and inserted values into a single string.

The server may insert explicit section cues or instructions within the text to facilitate structured output, such as adding phrases instructing the generative AI model to describe background, values, behavior, and purchasing behavior separately.

The server outputs a complete prompt sentence, such as “You are a generative AI model that creates detailed personas. Please generate a persona who is in their thirties, has an innovative thinking style, and enjoys music as a hobby. Describe their background, daily routine, values, technology usage, and how they evaluate new consumer products, especially audio devices and music-related services.”

### Step 6

The server constructs generation request data for the generative AI model.

The server takes the prompt sentence as input and combines it with model control parameters stored in configuration, such as maximum output length, temperature, and decoding mode.

The server encapsulates the prompt and parameters into a request structure and serializes the structure into a message suitable for an AI service interface.

The server signs or annotates the request with authentication credentials and routing information.

The server outputs a serialized generation request ready to be transmitted to the generative AI model.

### Step 7

The server sends the generation request to the generative AI model and receives persona text as output.

The server takes the serialized generation request as input and transmits it via a network interface to hardware that hosts the generative AI model.

The generative AI model executes on an accelerator platform and performs tokenization of the prompt sentence, embedding of tokens, transformer layer computations, and autoregressive decoding to produce output tokens.

The AI model converts the generated token sequence into text and returns this text to the server.

The server receives the text as persona output and outputs a raw persona text string that describes the persona's background, values, behavior, and purchasing tendencies.

### Step 8

The server structures and classifies the raw persona text.

The server takes the raw persona text as input and parses the text to identify logical segments.

The server applies rule-based parsing, markers embedded in the text (such as headings “Background:” or “Values:”), or a lightweight classifier to allocate portions of the text into categories: background information, values information, behavioral characteristic information, and purchasing behavior information.

The server performs string operations such as splitting at headings, trimming whitespace, and merging adjacent sentences belonging to the same category.

The server outputs a structured persona object containing category-specific fields mapped to corresponding text segments.

### Step 9

The server stores the structured persona object and associated metadata.

The server takes the structured persona object and the normalized attribute record as input and generates a database record with unique identifiers.

The server writes the fields for age range, thinking tendency, preference, and each persona category into a storage system, and records timestamps and links to the prompt sentence and model version used.

The server ensures that indices are updated to enable fast retrieval by attribute filters.

The server outputs a stored persona entry that can be accessed by identifier or by attribute-based queries.

### Step 10

The server generates additional prompt sentences for evaluation content.

The server takes the stored persona entry and a product or service proposal specification as input and reads specific persona fields, such as values and purchasing behavior, from storage.

The server combines these fields with proposal information using another natural language template designed for evaluation queries, and constructs a new prompt sentence that asks how this persona would evaluate proposed features or pricing.

The server may include explicit instructions for structured evaluation, such as requesting pros and cons, likelihood of adoption, and concerns.

The server outputs an additional prompt sentence tailored to obtain evaluation content from the generative AI model.

### Step 11

The server requests and receives evaluation content from the generative AI model.

The server takes the additional prompt sentence as input and performs operations analogous to those in Step 6 and Step 7: the server creates an evaluation request structure, transmits it to the generative AI model, and obtains generated evaluation text as an output.

The server receives the evaluation text and performs basic text normalization, such as removal of extraneous leading or trailing characters and unneeded control sequences.

The server outputs an evaluation content string that expresses the persona's assessment of the product or service proposal.

### Step 12

The server classifies and associates the evaluation content with product development stages.

The server takes the evaluation content and context information about the current development phase as input.

The server applies rule-based logic or predefined mappings that associate evaluation types with stages such as concept planning, feature refinement, or pricing evaluation, and assigns a stage label to the evaluation content.

The server stores the labeled evaluation content in the storage system together with references to the persona identifier and proposal identifier.

The server outputs a structured evaluation record that is indexed both by stage and by persona.

### Step 13

The server generates response data for the terminal.

The server takes the stored persona entry and one or more evaluation records as input and constructs a response structure that groups persona categories and stage-specific evaluation content into a format suitable for display.

The server converts the internal data representation into a serializable form and attaches display hints, such as section labels and ordering information.

The server sends the response structure to the terminal via the communication interface.

The server outputs a response message that enables the terminal to render a unified view of persona information and associated evaluations.

### Step 14

The terminal receives and displays the persona and evaluation content.

The terminal takes the response message from the server as input and parses the message into a client-side data structure.

The terminal generates user interface components corresponding to each category of persona information and each development stage evaluation, and arranges them on the display according to layout rules.

The terminal renders text in appropriate sections (for example, background, values, behavior, purchasing behavior, concept evaluation, pricing evaluation) and provides scrolling or navigation controls for the user.

The terminal outputs a visually structured screen that the user can review to understand how different personas perceive and evaluate product or service proposals.

### Step 15

The user reviews the displayed information and may trigger further refinement.

The user takes the displayed persona and evaluation content as input and, by observing reactions across stages, may decide to adjust attribute inputs or product proposal parameters.

The user interacts with the terminal to change attribute values or proposal settings, which causes the terminal to generate new attribute or proposal data.

The terminal sends the updated data back to the server, where the same normalization, prompt generation, and evaluation pipeline is reapplied.

The user thereby outputs new operational conditions that drive the server-side computation, allowing iterative refinement based on technically managed persona generation and evaluation processes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented techniques for utilizing personas in product development and advertising planning suffer from several technical shortcomings in the way digital information is generated, structured, and processed. In many existing systems, a processor merely stores user demographic inputs and manually authored persona descriptions, and then presents these descriptions as static text. Such systems do not automatically transform raw user attribute information into machine-usable data structures through interaction with a generative AI model. As a result, these systems require significant manual intervention, including manual drafting of persona narratives, manual extraction of attributes, and manual derivation of advertising strategies, which leads to increased processing latency, inconsistent data representation, and inefficient use of storage and computation resources.

Furthermore, in typical implementations, a processor does not perform systematic tokenization and numerical computation flows specialized for persona generation, and does not iteratively generate and refine prompt sentences based on previously generated persona data and analysis results. This lack of an integrated prompt-generation pipeline causes suboptimal utilization of generative AI models. The models are often used in an ad hoc manner, with unstructured prompts and unstructured outputs, which prevents the processor from automatically building consistent structured data sets for downstream analytics. Consequently, it is difficult to compute characteristic indices of target groups, to automatically recommend product specification improvements, or to algorithmically select suitable advertising media, in a reproducible and scalable way.

Additionally, known systems that incorporate machine learning frequently treat generative outputs as mere text documents and do not implement dedicated extraction and structuring mechanisms to convert the outputs into normalized attribute sets. Without such mechanisms, the processor cannot reliably perform automated segmentation, cannot efficiently query or update persona records, and cannot effectively maintain a feedback loop between persona generation and strategy generation. This leads to technical inefficiencies such as redundant computations, increased I/O overhead due to unstructured logs, and degraded responsiveness when multiple user terminals access the service concurrently.

Accordingly, there is a need for a computer-implemented system and methods that technically improve the way a processor: (i) generates prompt sentences for a generative AI model from user attribute information; (ii) executes tokenization and numerical computations to produce persona-related response text; (iii) extracts and structures persona attributes from the response text; and (iv) generates, on the basis of such structured data, machine-usable analysis results and advertising strategy proposals. By improving these processing stages and their interconnection, the invention aims to enhance the efficiency, consistency, and scalability of persona-based analytics on computing hardware.

The specific processing by the specific processing unit 290 of the data processing device 12 in Application Example 1 is realized by the following means.

The present invention provides a server comprising a processor configured to receive input information including attribute information from a user terminal, analyze the input information to construct text data including the attribute information, and generate a prompt sentence for a generative AI model; the processor further configured to convert the prompt sentence into a sequence of tokens, execute numerical computation processing on the sequence of tokens using the generative AI model to generate response text data indicating a virtual person, and extract attributes of the virtual person from the response text data to generate persona data as structured data; the processor further configured to store the structured persona data, generate analysis result data including product specification information and strategy information related to advertising activities on the basis of the persona data, generate an additional prompt sentence on the basis of the persona data and the analysis result data, input the additional prompt sentence into the generative AI model to cause generation of text data indicating an advertising strategy proposal, and output the advertising strategy proposal and the analysis result data to the user terminal. This enables a technical improvement in computer operation by transforming raw user attribute information into structured persona representations through token-based numerical processing, by automatically deriving target-group characteristic indices and corresponding strategy proposals, and by reducing manual intervention and unstructured processing, thereby achieving more efficient use of processing resources, lower latency, and more consistent data handling in persona-driven product development and advertising planning workflows.

The term “processor” refers to an information processing circuitry or execution unit, including one or more central processing units, graphics processing units, or other computation units, that executes instructions to perform data reception, analysis, transformation, storage, and output operations as described herein.

The term “user terminal” refers to an electronic device operated by a user, including but not limited to a communication device, a portable computing device, or a workstation, that transmits input information to the server and receives output information from the server via a communication network.

The term “input information” refers to digital data received from the user terminal, including at least attribute information such as demographic information, preference information, behavioral tendency information, or other user-related information used to construct a prompt sentence.

The term “attribute information” refers to one or more data elements representing characteristics of a person or target audience, including, for example, age-related information, value-related information, preference-related information, lifestyle-related information, or media usage information.

The term “prompt sentence” refers to text data constructed by the processor that encodes one or more instructions, conditions, or descriptions, and that is provided as input to a generative AI model to cause the generative AI model to perform a specific generation operation.

The term “generative AI model” refers to a machine learning model, such as a neural network model, that receives the prompt sentence as input and generates output data including response text data by performing token-based numerical computation.

The term “sequence of tokens” refers to an ordered list of discrete symbolic units, obtained by tokenizing the prompt sentence, where each unit corresponds to a segment of text such as a character, a subword, or a word, and is used as an input unit for the generative AI model.

The term “numerical computation processing” refers to execution of arithmetic operations, including matrix operations and non-linear transformations, on numerical representations of tokens or other data, by the processor and the generative AI model to generate output data.

The term “response text data” refers to text data output from the generative AI model in response to the prompt sentence, the text data indicating content such as a description of a virtual person or an advertising strategy proposal.

The term “virtual person” refers to an artificial persona representation, generated based on attribute information, that models characteristics, behaviors, and preferences of a hypothetical member of a target audience.

The term “persona data” refers to structured data generated by the processor by extracting attributes of the virtual person from the response text data, the structured data including one or more fields representing characteristics, preferences, or behaviors of the virtual person.

The term “structured data” refers to data stored in a format with a predefined schema, such as a table structure, a record structure, or another formal data structure, enabling the processor to perform querying, aggregation, and analysis operations on the data.

The term “analysis result data” refers to data generated by the processor based on the persona data, the analysis result data including information such as product specification information, strategy information related to advertising activities, and characteristic indices of a target group.

The term “product specification information” refers to data indicating one or more features, functions, or parameters of a product or service, recommended or derived based on analysis of the persona data and the characteristic indices of a target group.

The term “strategy information related to advertising activities” refers to data indicating one or more advertising strategies, including recommended messages, content formats, distribution channels, or media types, derived based on the persona data and analysis result data.

The term “additional prompt sentence” refers to a prompt sentence generated by the processor using at least the persona data and the analysis result data, and provided as further input to the generative AI model to obtain refined or additional output, such as an advertising strategy proposal.

The term “advertising strategy proposal” refers to text data or structured data indicating a proposed plan for advertising activities, including recommended advertising messages, target channels, content types, or scheduling suggestions, generated by the generative AI model based on the additional prompt sentence.

The term “attribute element” refers to a unit element of information extracted from the response text data, including, for example, value information, behavioral pattern information, or information acquisition channel information, used for computing characteristic indices.

The term “value information” refers to an attribute element representing beliefs, priorities, or evaluation criteria of the virtual person or target audience, such as importance placed on environmental impact, price, or quality.

The term “behavioral pattern information” refers to an attribute element representing typical behaviors or activity patterns of the virtual person or target audience, such as purchasing frequency, usage situations, or content consumption habits.

The term “information acquisition channel information” refers to an attribute element representing one or more channels or media through which the virtual person or target audience obtains information, such as social networking services, video streaming services, or online search services.

The term “characteristic indices of a target group” refers to quantitative or qualitative indicators computed by the processor based on one or more attribute elements of one or more virtual persons, the indicators representing aggregated or representative characteristics of a target audience group.

In one embodiment, a server implements a persona-based analysis system using a combination of hardware and software components configured to execute a generative AI model in response to prompt sentences derived from user input information.

The server comprises a processor, a memory, a storage device, and a network interface. The server uses a general-purpose computing platform, for example a rack-mounted computing device or a virtual computing instance provided on a cloud computing platform. The processor includes at least one central processing unit and optionally at least one graphics processing unit for accelerated numerical computation. The memory stores executable instructions, model parameters, and intermediate data structures. The storage device stores trained neural network models, tokenization dictionaries, and persona records. The network interface enables communication with at least one terminal over a communication network such as the Internet.

The terminal comprises a user interface device, such as a portable communication device or a desktop computing device, executing a web browser or a dedicated application. The user operates the terminal to input attribute information. The terminal sends the input information to the server and receives persona-related information and advertising strategy information from the server.

The user operates the terminal to display an input screen that includes fields for attribute information, such as age-related information, thinking tendency information, and hobby information. The terminal transmits, through the network interface, the input information to the server as digital data. The server receives the digital data and stores the data into the memory as input information.

The server uses software components implemented in a general-purpose programming language and a numerical computation framework to process the input information. In one embodiment, the server uses an interpreter environment, a machine learning framework, and auxiliary libraries including a text processing library and a data analysis library. The server loads into the memory a generative AI model implemented as a neural network, for example a transformer-based language model comprising multiple attention layers, feedforward layers, and normalization layers.

The server analyzes the input information received from the terminal. The server parses the attribute information and maps the attribute information into internal data fields, such as an age group field, a value tendency field, and an interest field. The server constructs a prompt sentence from the attribute information. The server uses text templates stored in the memory to build prompt sentences in natural language. For example, when the user has entered “20s” as age-related information, “interested in environmentally friendly products” as thinking tendency information, and “outdoor activities” as hobby information, the server constructs a prompt sentence such as:

Age group: 20s

Thinking tendency: interested in environmentally friendly products

Hobby: outdoor activities

Based on the information above, generate a detailed virtual persona that represents a typical member of the target audience. Describe lifestyle, values, preferred media channels, and purchasing behavior.

The server may construct other prompt sentences for additional processing. For example, the server may construct an additional prompt sentence using previously generated persona data:

Persona summary:
Age group: 20s
Values: cares deeply about environmental issues, prefers environmentally friendly products
Lifestyle: spends weekends hiking or camping
Preferred channels: social networking services, video streaming services

Based on this persona, draft an advertising strategy. Propose specific advertising messages, recommended channels, and content formats that would effectively reach this target audience. The server converts the prompt sentence into a sequence of tokens using a tokenizer component associated with the generative AI model. The tokenizer maps characters, words, or subwords to discrete token identifiers. The server pads or truncates the sequence to a predetermined length and converts the sequence into a numerical tensor representation. The server transfers the tensor into a computation device such as a graphics processing unit. The server executes the generative AI model by performing numerical computation processing on the tensor. In one embodiment, the generative AI model is a transformer architecture including an embedding layer, multiple self-attention layers, feedforward layers, and an output layer. Each self-attention layer computes attention weights by applying a scaled dot-product operation to query, key, and value vectors derived from the input token embeddings. Each feedforward layer applies a linear transformation, a non-linear activation function, and a second linear transformation to the intermediate representations. The server uses a softmax function to convert the output logits into token probability distributions. The server generates output tokens by selecting token identifiers according to a decoding strategy such as greedy decoding, beam search, or top-k sampling. The server converts the output token identifiers back into response text data using the tokenizer.

The server trains the generative AI model in advance using a training dataset stored in the storage device. During training, the server performs minibatch gradient descent to minimize a loss function such as cross-entropy between predicted token distributions and ground-truth tokens. The server updates the model weights using an optimization algorithm such as stochastic gradient descent or adaptive moment estimation. The server may apply regularization techniques, such as dropout or weight decay, and data augmentation techniques, such as randomized masking of tokens, to improve generalization. Once trained, the server stores the model parameters in the storage device and loads the parameters into the memory during inference.

The server extracts persona attributes from the response text data. The server uses rule-based text analysis, pattern matching, and optionally auxiliary classification models to identify attribute elements such as value information, behavioral pattern information, and information acquisition channel information. The server converts these attribute elements into persona data represented as structured data, for example as records in a tabular data structure with fields for demographic attributes, psychographic attributes, media usage attributes, and purchasing behavior attributes.

The server stores the persona data in a data repository such as a relational data store. The server associates each persona record with an identifier and a timestamp. The server maintains indexes on fields such as age group, primary values, or primary channels to enable efficient retrieval and aggregation. The server computes characteristic indices of target groups by aggregating attribute elements across multiple persona records. The server uses aggregation operations such as frequency counting, averaging, and clustering of attribute elements, implemented by data analysis libraries, to derive indices including channel preference scores, message sensitivity scores, and product feature preference scores.

The server generates analysis result data using the persona data and the characteristic indices. The server maps combinations of indices to suggested product specification information and suggested advertising strategy information. For example, when the server determines that a target group shows high preference for environmentally friendly features and frequent use of visual social networking platforms, the server generates data recommending that a product specification emphasize sustainable materials and that an advertising strategy emphasize visual storytelling on those platforms.

The server constructs an additional prompt sentence that includes persona data and analysis result data. The server inputs the additional prompt sentence into the generative AI model. The server performs tokenization and numerical computation in the same manner as for persona generation. The server obtains response text data indicating an advertising strategy proposal. The server may include in the additional prompt sentence explicit instructions to output structured items such as key messages, channels, content formats, and scheduling guidance. The server parses the advertising strategy proposal to obtain structured strategy information.

The server outputs the persona data, the analysis result data, and the advertising strategy proposal to the terminal. The server formats the data into a response suitable for display, such as a structured data response or marked-up text. The terminal receives the response and presents the persona narrative, key attributes, and recommended advertising strategy on a display device. The user views the display and can revise attribute information or request further scenarios.

The server improves computer technology by implementing specific data structures and computation flows optimized for generative AI-based persona processing. The server uses structured persona records, index data, and characteristic indices to reduce the need to regenerate entire persona descriptions for similar attribute inputs. The server caches intermediate persona data in the storage device and reuses these data when generating additional strategies, thereby reducing redundant computations. The server organizes persona data into normalized schemas that allow efficient querying using index-based retrieval rather than full-text search, which reduces processing time and I/O load when handling large volumes of persona records.

The server improves processing speed and scalability by offloading matrix operations and attention computations of the generative AI model onto a graphics processing unit. The server partitions computations into minibatches of prompt sentences, enabling parallel processing of multiple user requests. The server reduces communication load by returning only structured persona data and compressed strategy summaries to the terminal, avoiding unnecessary transmission of full intermediate model outputs. The server stores precomputed tokenization dictionaries and model weights in the memory to avoid repeated loading from the storage device.

The server improves accuracy and consistency by enforcing a standardized prompt sentence format and a standardized extraction schema. The server constructs prompt sentences using templates that encode explicit instructions about the required output structure. This reduces variability in response text data and improves the reliability of attribute extraction. The server uses predefined patterns and attribute vocabularies to map natural language segments into standardized attribute fields, reducing classification errors and improving the precision of characteristic indices.

The server differs from human manual persona creation and manual strategy drafting, because the server applies a combination of high-dimensional numerical computations, algorithmic tokenization, and rule-based extraction that cannot be practically replicated by human operators at similar speed or scale. The server applies non-intuitive combinations of features, such as attention-based weighting of word segments across the entire prompt sentence, that produce latent persona representations not based on simple keyword matching. The server applies non-conventional processing steps, such as iterative prompt refinement based on prior analysis results and automatic segmentation into characteristic indices, which improve the performance of the underlying computing system rather than simply automating a known manual business workflow.

In another embodiment, the server uses an alternative neural network architecture, such as a sequence-to-sequence recurrent neural network with attention mechanisms, instead of a transformer model. The server still applies tokenization and numerical computation to map prompt sentences to response text data. The recurrent neural network processes tokens sequentially, and an attention mechanism computes alignment scores between encoder states and decoder states. The server trains the recurrent network using a similar loss function and optimization method.

In yet another embodiment, the server uses a hybrid approach combining a generative AI model with a rule-based post-processor. The server uses the generative AI model to produce an initial persona narrative, and then uses deterministic rules and classification thresholds to adjust attribute assignments. For example, when the generated text indicates “frequent checking of product reviews on comparison sites,” the server maps this phrase to a predefined information acquisition channel category. This hybrid approach enhances stability and reduces variance in attribute extraction, further improving the technical performance of the system.

In another variation, the server deploys the generative AI model across multiple computation nodes and uses a load balancing mechanism. The server distributes prompt sentences across nodes, aggregates responses, and updates shared persona data storage. By managing model inference as a distributed service, the server maintains low latency even under high user request volume. The server monitors processor utilization, memory usage, and response times, and dynamically adjusts batch sizes and decoding strategies to maintain system throughput.

In still another embodiment, the terminal implements local pre-validation of attribute information and local caching of previously requested attribute sets. The terminal detects when the user inputs attribute information identical to a prior query and requests from the server a previously computed persona and strategy, using an identifier, rather than requesting a full regeneration. This reduces network traffic and server computation load, further improving system efficiency.

Through these embodiments and variations, the server, the terminal, and the user cooperate to implement a technical system that uses a generative AI model and prompt sentences in a specific, structured manner. The system converts human-readable attribute information into machine-usable token sequences, executes defined numerical algorithms within a neural network architecture, and transforms unstructured response text data into structured persona data and characteristic indices. As a result, the system achieves improved processing speed, enhanced accuracy in persona attribute extraction, reduced communication load, and more efficient data management, thereby providing a concrete improvement in the functioning of computer systems that perform persona-based analysis and advertising strategy generation.

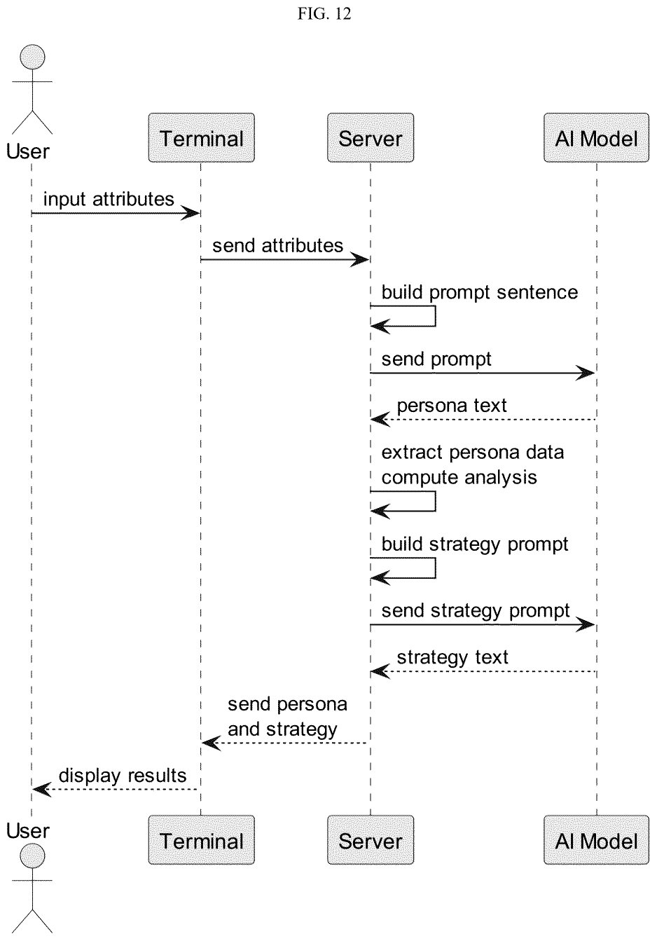

The following describes the processing flow using FIG. 12.

### Step 1

The user operates the terminal to open an application and display an input screen including fields for attribute information such as age group, thinking tendency, and hobby. The input of this step is the user's raw textual entries (for example, “20s”, “interested in environmentally friendly products”, “outdoor activities”). The terminal validates basic constraints on the input, such as non-empty fields and maximum length, and then converts the input into an internal data structure. The output of this step is structured input information stored in the terminal's memory, ready to be transmitted to the server.

### Step 2

The terminal sends the structured input information to the server via a communication network using a request message. The input of this step is the structured attribute information stored in the terminal. The terminal encapsulates this information into a message, attaches necessary metadata such as a request identifier and timestamp, and transmits the message to a predefined network address of the server. The output of this step is a network message containing the attribute information that arrives at the server.

### Step 3

The server receives the request message through a network interface and decodes the message to obtain the input information. The input of this step is the network message sent from the terminal. The server parses the message header and body, verifies that required attribute fields are present, and maps the raw data into internal variables (for example, an age group variable, a thinking tendency variable, and a hobby variable). The output of this step is validated attribute information stored in the server's memory.

### Step 4

The server generates a prompt sentence for a generative AI model based on the validated attribute information. The input of this step is the set of internal variables representing the user's attributes. The server applies a text template and combines the variables into a natural language description, performing string concatenation and formatting operations. For example, the server generates a prompt sentence such as:

Age group: 20s

Thinking tendency: interested in environmentally friendly products

Hobby: outdoor activities

Based on the information above, generate a detailed virtual persona that represents a typical member of the target audience. Describe lifestyle, values, preferred media channels, and purchasing behavior.

The output of this step is a formatted prompt sentence stored as text data.

### Step 5

The server tokenizes the prompt sentence and converts it into numerical input for the generative AI model. The input of this step is the prompt sentence text generated in Step 4. The server uses a tokenizer associated with the model to split the text into a sequence of tokens and then map each token to a numerical identifier. The server arranges the identifiers into a fixed-length sequence, pads or truncates as necessary, and constructs a tensor representation suitable for the generative AI model. The output of this step is a numerical tensor containing token identifiers and, optionally, position indices.

### Step 6

The server executes the generative AI model to generate response text data describing a virtual person. The input of this step is the tensor produced in Step 5. The server passes the tensor through the neural network layers of the generative AI model, performing matrix multiplications, attention computations, and non-linear activations on a computation device such as a graphics processing unit. The server decodes the resulting output distributions into a sequence of output token identifiers according to a decoding strategy and then converts the output token identifiers back into natural language text. The output of this step is response text data that describes a virtual person, stored as text in the server's memory.

### Step 7

The server extracts persona attributes from the response text data and constructs persona data as structured data. The input of this step is the generated response text describing the virtual person. The server applies rule-based pattern matching, keyword detection, and optional auxiliary classifiers to locate segments corresponding to values, behaviors, and information acquisition channels. The server maps these segments into predefined fields in a persona schema, such as value information, behavioral pattern information, and preferred media channels. The output of this step is persona data represented in a structured format, such as a record or table row.

### Step 8

The server stores the persona data and computes characteristic indices of a target group. The input of this step is the structured persona data from Step 7, optionally combined with previously stored persona records. The server writes the persona record into a data repository and updates aggregates such as frequency counts and averages for relevant attributes. The server computes characteristic indices, for example a channel preference score or a message sensitivity score, by applying statistical aggregation and normalization functions to the persona data. The output of this step is an updated persona repository and a set of characteristic indices stored for later use.

### Step 9

The server generates analysis result data for product specification and advertising strategy based on the persona data and the characteristic indices. The input of this step is the persona data and the computed characteristic indices. The server applies decision rules and mapping tables to translate indices and attributes into suggested product features and candidate advertising approaches. For example, the server maps high environmental value emphasis and high visual social channel usage to a recommendation for sustainable materials and visually focused messaging. The output of this step is analysis result data including product specification information and strategy information related to advertising activities.

### Step 10

The server generates an additional prompt sentence for the generative AI model to obtain a detailed advertising strategy proposal. The input of this step is the persona data and analysis result data. The server constructs a summarized persona description and embeds the suggested product and channel context into a new text template. The server produces an additional prompt sentence such as:

Persona summary:
Age group: 20s
Values: cares deeply about environmental issues, prefers environmentally friendly products
Lifestyle: spends weekends hiking or camping
Preferred channels: social networking services, video streaming services

Based on this persona, draft an advertising strategy. Propose specific advertising messages, recommended channels, and content formats that would effectively reach this target audience.

The output of this step is a second prompt sentence stored as text data.

### Step 11

The server processes the additional prompt sentence through the generative AI model to generate an advertising strategy proposal. The input of this step is the additional prompt sentence generated in Step 10. The server tokenizes the sentence, converts it into a numerical tensor, and executes the generative AI model in the same manner as in Step 6. The server decodes the model output into text describing advertising messages, channels, and content formats. The output of this step is response text data representing an advertising strategy proposal.

### Step 12

The server structures and combines the persona data, analysis result data, and advertising strategy proposal for transmission. The input of this step is the persona data from Step 7, the analysis result data from Step 9, and the advertising strategy text from Step 11. The server formats these components into a response structure, grouping persona attributes, characteristic indices, and strategy elements into clearly labeled sections. The server may compress the data or remove redundant intermediate information to reduce response size. The output of this step is a response dataset ready for sending to the terminal.

### Step 13

The server sends the response dataset to the terminal over the communication network. The input of this step is the formatted response dataset created in Step 12. The server generates a response message, attaches status codes and metadata, and transmits the message via the network interface. The output of this step is a network message carrying persona information and advertising strategy information that reaches the terminal.

### Step 14

The terminal receives and decodes the response dataset and displays the results to the user. The input of this step is the network message sent by the server. The terminal parses the message, extracts the persona description, structured attributes, and advertising strategy proposal, and renders them on the display as text and graphical elements. The terminal may arrange persona characteristics in one section and recommended strategies in another section. The output of this step is a visual presentation of the generated persona and strategy on the terminal's screen.

### Step 15

The user reviews the displayed persona and strategy and optionally modifies the input conditions for further iterations. The input of this step is the displayed information on the terminal screen. The user interprets the persona attributes and strategy proposal, decides whether the results are satisfactory, and, if necessary, changes attribute information such as age group or thinking tendency on the input screen. The output of this step is new or adjusted attribute information, which can be re-entered into the system, causing the flow from Step 1 to be executed again.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented techniques for supporting product development using persona-based analysis typically rely on static, manually authored persona descriptions or on ad hoc use of generative AI outputs that are not tightly integrated into the software architecture. In such systems, a computing device often treats personas and their evaluations as unstructured text, without systematic normalization of user input, without structured association between personas and product design artifacts, and without iterative, machine-controlled updating of evaluations across different stages of product development. As a result, the underlying computer system is not optimized for handling large volumes of heterogeneous persona data and evaluations, leading to inefficiencies such as redundant model calls, inconsistent prompt construction, and difficulty in retrieving persona-specific evaluations aligned with particular development phases.

Furthermore, existing systems generally do not configure a processor to automatically generate different types of prompt sentences tailored to distinct computational objectives, such as persona generation versus product evaluation, based on normalized attribute information and decomposed product design information. Instead, prompt sentences are often hand-crafted by human operators, causing variability in quality and making it difficult for the machine to consistently leverage generative AI models as part of a repeatable, scalable pipeline. This results in increased processing overhead, reduced reproducibility of results, and suboptimal utilization of storage structures and model inference resources.

Additionally, conventional approaches lack mechanisms for managing persona information and evaluation information in association with explicit process information of product development, and for iteratively updating evaluations based on user interactions such as annotations and attention indications. Without such mechanisms, the computer system cannot efficiently orchestrate feedback cycles across multiple development stages, and cannot systematically reconfigure prompt sentences or regenerate evaluations in response to evolving design states stored in the system. This leads to fragmented data, burdensome manual coordination, and an overall degradation of the computer's ability to provide timely, persona-aligned analytical output.

Accordingly, there is a need for an improved computer-implemented system and server configuration that structurally integrates: (i) normalization and structured storage of attribute information and product design information, (ii) automated generation of multiple classes of prompt sentences for a generative AI model, (iii) structured storage and aggregation of persona information and evaluation information, and (iv) iterative updating of evaluations in coordination with product development processes and user interactions. Such a configuration should enhance the efficiency, consistency, and technical functioning of the underlying computer system in generating and using persona-based evaluations for product design.

The specific processing by the specific processing unit 290 of the data processing device 12 in Example 2 is realized by the following means.

The present invention provides a server comprising a processor and a storage device, the processor being configured to receive, from a user terminal, input information including attribute information and product design information, normalize and validate the input information, and store the normalized input information in the storage device as structured data; to generate a first prompt sentence for input to a generative AI model based on the attribute information, transmit the first prompt sentence to the generative AI model, receive persona information including a plurality of virtual person records from the generative AI model, convert the persona information into structured data, and store the structured persona data in association with the attribute information; to generate, based on the product design information and the structured persona data, a second prompt sentence for obtaining evaluation information from viewpoints of respective personas, transmit the second prompt sentence to the generative AI model, receive evaluation information corresponding to the respective personas, and store the evaluation information in association with the corresponding persona data and product design information; to aggregate a plurality of pieces of stored evaluation information and compute analysis information indicating at least one of a degree of conformity to market requirements and improvement points with respect to the product design information; and to manage the persona information and the evaluation information in association with process information of product development, to update the first and second prompt sentences based on user-provided annotations or attention indications, and to iteratively regenerate and update evaluation information by repeated invocation of the generative AI model. This enables the computer system to improve its technical operation by systematically structuring diverse user and model data, by automatically constructing and managing multiple classes of prompt sentences for a generative AI model, by reducing redundant and inconsistent model interactions, and by efficiently coordinating persona-based evaluations with product development processes, thereby enhancing processing efficiency, data consistency, and the quality and timeliness of computer-generated analytical output for product design improvement.

The term “processor” refers to a hardware-implemented information processing element, such as a central processing unit or a processing circuit, configured to execute instructions and perform arithmetic and logical operations for controlling functions of the system.

The term “storage device” refers to a hardware-implemented memory component, such as a semiconductor memory, a magnetic storage medium, or an optical storage medium, configured to store programs, input information, intermediate data, persona information, evaluation information, and analysis information.

The term “terminal” refers to an information processing apparatus operated by a user, such as a portable information device, a personal computer, or another communication-capable device, configured to transmit input information to the server and to receive and present output information from the server.

The term “input information” refers to information transmitted from the terminal to the server, including at least attribute information relating to virtual persons and product design information relating to a product to be evaluated.

The term “attribute information” refers to information representing characteristics of a virtual person, including at least one of an age group, an occupation, a thinking tendency, a preference, a hobby, a region, or another demographic or psychographic characteristic.

The term “product design information” refers to information representing a design of a product, including at least one of a product category, a design concept, a functional specification, a feature list, a target market, or a phase in a product development process.

The term “normalization” refers to a process of converting input information into a standardized form, including at least one of unifying expressions, adjusting formats, splitting composite information, and mapping variable expressions to canonical categories.

The term “validation” refers to a process of checking input information for correctness, completeness, and conformity to predetermined rules, including at least one of range checks, type checks, mandatory field checks, and character set checks.

The term “structured data” refers to information stored in a predetermined data structure, such as a record, a table, or a tree structure, enabling retrieval, association, and processing by the processor based on defined fields and relationships.

The term “generative AI model” refers to an information processing model implemented by a machine learning system that is configured to generate output information, such as natural language text, based on an input sequence of symbols, and that may include a neural network, a probabilistic model, or another generative model architecture.

The term “prompt sentence” refers to a sequence of symbols, including at least a natural language expression, transmitted as input to the generative AI model to cause the generative AI model to perform a specific generation task, such as creating persona information or evaluation information.

The term “first prompt sentence” refers to a prompt sentence generated based on attribute information, configured to cause the generative AI model to generate persona information describing one or more virtual persons.

The term “second prompt sentence” refers to a prompt sentence generated based on product design information and persona information, configured to cause the generative AI model to generate evaluation information expressing opinions or assessments from viewpoints of the virtual persons.

The term “persona information” refers to information output by the generative AI model in response to the first prompt sentence, representing at least one virtual person, and including at least one of a background, a lifestyle, a preference, a value, a behavior pattern, or another characteristic.

The term “virtual person” refers to a fictitious entity having attribute information and behavioral characteristics, generated by the generative AI model and used as a conceptual representation of a category of potential users or consumers.

The term “evaluation information” refers to information output by the generative AI model in response to the second prompt sentence, representing opinions, impressions, assessments, or suggestions of a virtual person with respect to product design information.

The term “analysis information” refers to information computed by the processor based on a plurality of pieces of evaluation information and the product design information, indicating at least one of a degree of conformity to market requirements, a frequency of mention of features, a sentiment measure, or a candidate improvement point.

The term “market requirements” refers to needs, expectations, preferences, or constraints of potential users or consumers in a marketplace with respect to a product or its features.

The term “process information of product development” refers to information indicating at least one stage or phase in a product development lifecycle, including planning, concept design, detailed design, prototyping, testing, and modification.

The term “annotation information” refers to information input by a user in association with evaluation information, including at least comments, tags, or labels that indicate the user's interpretation, priority, or categorization of the evaluation information.

The term “attention information” refers to information representing a degree of interest or emphasis indicated by the user with respect to particular evaluation information, including at least one of selection, highlighting, bookmarking, or weighting operations.

The term “aggregation” refers to a process in which the processor combines a plurality of pieces of evaluation information, performs statistical or logical operations, and derives collective indicators or summaries for use in analysis information.

The term “natural language processing technology” refers to computational techniques for handling human language data, including at least tokenization, morphological analysis, syntactic analysis, semantic analysis, and text generation, which are used to construct prompt sentences and process outputs from the generative AI model.

In one embodiment, a server includes at least one processor, a main memory, a non-volatile storage device, and a network interface. The server uses a general-purpose processing unit such as an x86-compatible central processing unit, a graphics processing unit for accelerating neural network inference, a semiconductor memory such as dynamic random access memory, and a non-volatile storage device such as a solid-state drive. The server executes an operating system such as a general-purpose server operating system, a web server program such as a reverse proxy, an application framework such as a web application framework implemented in a general-purpose programming language, and a database management system such as a relational database system.

The terminal is an information processing apparatus such as a smartphone, a tablet computer, or a personal computer, including a processor, a display, an input interface, a memory, and a communication module. The terminal executes an operating system such as a mobile operating system or a desktop operating system and a web browser or a native application.

The user operates the terminal via a touch panel, a keyboard, a pointing device, or a microphone.

The user uses the terminal to input attribute information and product design information. The terminal converts these inputs into structured data in a predefined schema and transmits the structured data to the server via a network using a transport protocol such as Hypertext Transfer Protocol Secure. The terminal may perform client-side format checking, but the main normalization and validation are performed by the server.

The server uses the processor to receive the structured data from the terminal via the network interface. The server stores the received data in the storage device using the database management system. The server normalizes the attribute information by performing operations including lowercasing, trimming of white spaces, canonicalization of synonyms, and mapping of free-text values to predefined category identifiers. The server normalizes the product design information by segmenting a design description into feature units, assigning functional tags to each feature, and extracting key phrases using a natural language processing library such as a tokenization and part-of-speech tagging tool.

The server uses a database schema including at least a persona attribute table, a persona table, a product design table, an evaluation table, and a mapping table associating personas and product designs. Each persona attribute record includes fields such as age_group, occupation_category, thinking_style_code, hobby_codes, and region_code. Each product design record includes fields such as category_code, concept_text, feature_list, target_segment_code, and development_stage_code. This specific data structure enables the server to perform indexed queries, join operations, and aggregations efficiently, thereby improving the data access time and reducing database load compared to unstructured storage.

The server generates a first prompt sentence for a generative AI model using the normalized attribute information. The server maintains, in the storage device, multiple prompt templates for persona generation, each template being a natural language sentence pattern with placeholders for attribute values. The server selects an appropriate template based on the combination of attribute categories and fills the placeholders with canonicalized attribute values. By using templates stored and selected in this manner, the server reduces variability and length of prompt sentences, which in turn reduces the number of tokens processed by the generative AI model and lowers both processing time and network bandwidth.

An example of a first prompt sentence generated by the server is as follows:

“You are a generative AI model that creates detailed consumer personas.

Create one virtual person based on the following attribute information.

Age group: 30s

Occupation: working parent

Thinking tendency: practical, time-conscious, cost-conscious

Hobbies: caring for children, online shopping

Region: urban area

Please describe:
Name (fictional),
Family situation,
Daily routine,
Main values and concerns,
Typical purchasing behavior,

in about 300-500 words.”

The server uses a generative AI model implemented as a neural network having a transformer architecture. The generative AI model includes an embedding layer, multiple self-attention layers, feed-forward layers, and an output projection layer. The model parameters include at least several hundred million weight values stored in a model parameter file. The server executes inference by loading the model parameters into the memory of the graphics processing unit and performing matrix multiplication and non-linear activation operations for each token in the input sequence.

The generative AI model is trained in advance using supervised learning on large-scale text data. During training, the model minimizes a loss function such as cross-entropy between predicted token distributions and ground-truth tokens. A gradient-based optimization algorithm updates the weights of the model using mini-batch stochastic gradient descent with adaptive learning rate control. The training process may use data augmentation, including random masking and sequence truncation, to improve generalization. Although the training is performed separately from operation of the system, the structure and training of the model influence the technical behavior of the server in inference mode.

The server sends the first prompt sentence to the generative AI model via an application programming interface. When the model is deployed as an external service, the server transmits the prompt sentence using a secure network protocol and receives the generated text as a sequence of tokens. When the model is deployed locally, the server directly calls an inference library that executes transformer computations on the graphics processing unit.

The server receives a text output representing persona information, and uses rule-based parsing combined with natural language processing techniques to convert the output into structured persona data. The server uses predetermined section markers or pattern rules to split the text into segments corresponding to fields such as name, background, values, and purchasing behavior. The server may use a named-entity recognition component or regular expressions to identify phrases corresponding to demographic features. The parsed persona data are stored in the persona table and associated with the original attribute information via foreign key relationships.

The server generates a second prompt sentence for each persona using both the product design information and the structured persona data. The server uses a second set of templates optimized for evaluation generation, which explicitly separate persona description from product description to stabilize the generative AI model's behavior. The server concatenates persona profile attributes and product features in a defined order, ensuring that important fields such as daily constraints and main concerns appear before the evaluation instruction. This ordering reduces ambiguity and improves consistency of evaluation outputs, thereby improving the accuracy and reproducibility of the computational result.

An example of a second prompt sentence generated by the server is as follows:

“You are the following virtual consumer:

Age: 32

Occupation: working parent in a large city

Thinking tendency: practical, time-saving, dislikes complicated settings

Hobbies: spending time with family, online shopping

Evaluate this product design from your own viewpoint.

Product: smartphone for busy parents

Features:
5-inch display
Easy one-hand operation while holding a child
Long battery life (at least one day)
Simple parental control (pre-set usage times and app restrictions)

Please explain:
(1) What you like,
(2) What you dislike or find inconvenient,
(3) What specific improvements you would suggest.

Write your answer in English, in natural, conversational language.”

The server transmits the second prompt sentence to the generative AI model and receives an evaluation text. The server stores the evaluation text in the evaluation table, including a reference to the persona record and the product design record. The server may also store metadata such as timestamp, model version, and generation parameters (for example, temperature and maximum token length).

The server analyzes multiple pieces of evaluation information using algorithms that compute keyword frequencies, sentiment scores, and feature-specific satisfaction scores. The server represents each evaluation as a vector in a feature space, where each dimension corresponds to a product feature or sentiment category. The server computes aggregated statistics such as mean sentiment per feature, frequency of negative feedback for each feature, and co-occurrence counts between persona attributes and complaints. By using vector operations and indexed columns in the database, the server performs these computations more efficiently than line-by-line text scanning.

The terminal receives aggregated analysis information from the server and displays it to the user. The terminal visually groups evaluations by persona and by product feature, and may provide color-coded indicators for positive and negative aspects. The user can select or highlight particular evaluations. The terminal sends selection data back to the server as attention information or annotation information.

The server records the attention information and annotation information in association with the corresponding evaluation records. The server uses this information to weight subsequent analyses and to modify prompt generation rules. For example, when many users annotate that screen size is a major issue, the server updates an internal rule set that increases the priority of screen-related feature descriptions in later second prompt sentences. This non-conventional feedback loop, implemented as machine-maintained weights and rules, improves the focus of subsequent model calls, reduces noise in generated evaluations, and decreases the number of iterations needed to converge on a stable design.

The server manages personas, product designs, evaluations, and process information of product development in an integrated manner. The server maintains a process table storing stages such as concept, prototype, and pre-launch. Each product design record is linked to a process stage. When the product design advances to a new stage, the server automatically selects relevant personas and regenerates evaluations specialized for that stage, using stage-specific prompt templates. For example, in a prototype stage, the template may emphasize usability and defect detection, while in a concept stage, the template may emphasize perceived value and expectations.

The server implements caching and deduplication mechanisms to reduce redundant generative AI model calls. For combinations of persona attributes and product features that have been evaluated previously, the server can retrieve and adapt existing evaluation information instead of regenerating it from the model. The server uses hash values of normalized input tuples to identify reuse candidates. This reduces network traffic and graphics processing unit load, and shortens latency for the user.

In another embodiment, the server deploys the generative AI model locally. The server loads the transformer model into graphics memory and uses a batched inference method. The server accumulates multiple prompt sentences into a batch and processes them in parallel in the same forward pass through the transformer layers. This batching significantly increases throughput and reduces overhead per request, thereby improving processing efficiency of the computer. The server schedules batches based on queue length and time thresholds, implementing a non-trivial scheduling algorithm rather than a simple first-come-first-served pipeline.

In another embodiment, the server uses a hybrid model composed of a rule-based module and a neural network-based generative AI model. The rule-based module pre-filters and restructures input information, while the neural model performs natural language generation. For instance, the rule-based module may automatically classify a design feature as “safety-related”, “usability-related”, or “aesthetic-related” and ensure that safety-related features are always placed in a higher priority section in the second prompt sentence. This hybrid approach differs from manual drafting because the rules are maintained and applied at machine speed, consistently across a large volume of data, enabling scalable and technically controlled utilization of generative models.

The system improves computer technology in several ways. First, by normalizing and structuring persona and design data before prompt generation, the server reduces token length and ambiguity in prompt sentences, which directly reduces computation time and error rates in transformer inference. Second, by managing persona, evaluation, and development-stage information in a unified, indexed schema, the server enables more efficient database queries and aggregation compared to conventional unstructured text storage. Third, by maintaining and dynamically updating prompt templates and internal rules based on user annotations, the server creates a feedback mechanism that systematically controls model inputs and improves the stability and relevance of generated outputs, reducing the need for repeated manual prompt crafting and lowering network and computational load.

The user uses the terminal to modify product design parameters based on analysis information provided by the server. The terminal sends updated design information to the server, which can automatically propagate the changes through its data structures, generate new prompt sentences, and obtain updated evaluations. The server logs the entire sequence of persona generation, evaluation generation, and design changes, enabling reproducible and auditable operation of the system.

Because the system configures the server, the terminal, and the generative AI model to interact through specific data structures, prompt templates, and batching and caching mechanisms, the system is not limited to abstract manipulation of information. Rather, it implements a concrete improvement in the way a computer stores, organizes, and processes data related to personas and product designs. The combination of normalized attribute data, structured persona and evaluation records, controlled prompt sentence generation, and batched transformer inference produces measurable technical advantages such as faster processing, more consistent outputs, and reduced resource consumption, beyond mere automation of human mental steps.

Various modifications can be made without departing from the scope of the invention. For example, the generative AI model may be replaced with another type of generative model, such as a sequence-to-sequence recurrent neural network or a convolutional neural network-based text generator, provided that the server still constructs and transmits first and second prompt sentences and receives generated persona and evaluation information. The database may be implemented as a document store instead of a relational store, provided that structured associations between personas, evaluations, and product designs are maintained. The terminal may be implemented as a head-mounted display device or other specialized user interface apparatus, provided that it can transmit input information to the server and display analysis information received from the server.

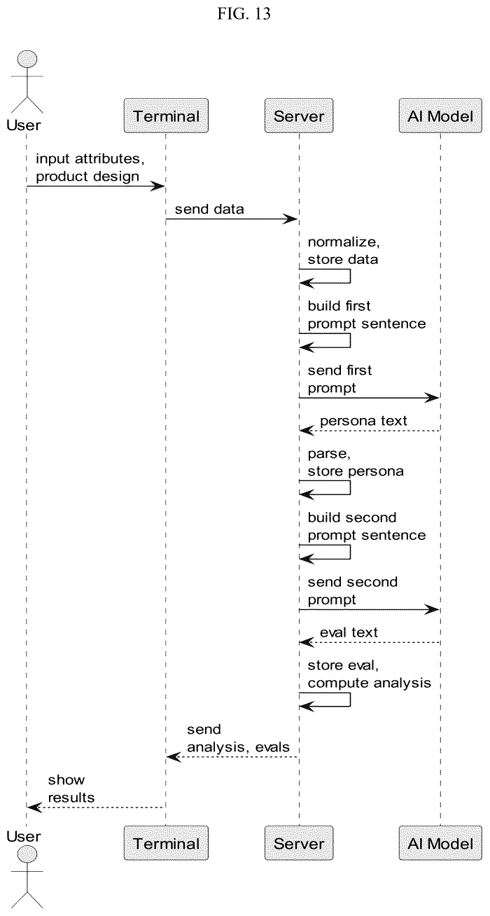

The following describes the processing flow using FIG. 13.

### Step 1

The user operates the terminal to input attribute information and product design information.

The terminal displays input forms for age group, occupation, thinking tendency, hobbies, region, product category, design concept, and feature list.

As input, the terminal receives raw text strings and selection values typed or selected by the user.

The terminal performs client-side checks, such as verifying that required fields are not empty and that fields like age group and product category match predefined options.

The terminal converts the validated inputs into a structured internal representation, for example mapping selection values to internal codes and grouping related fields into objects.

As output, the terminal generates a structured request payload and transmits it to the server via a secure network connection.

### Step 2

The server receives the structured request payload from the terminal.

As input, the server obtains a message including attribute information and product design information encoded in a predefined schema.

The server parses the payload, validates data types and allowed values, and performs normalization, including lowercasing text, trimming spaces, and mapping synonymous expressions to canonical codes.

The server uses a database interface to insert or update records in persona attribute tables and product design tables, assigning unique identifiers to each record.

As output, the server stores normalized attribute records and product design records in persistent storage and returns an acknowledgment message with assigned identifiers to the terminal if required.

### Step 3

The server generates a first prompt sentence for persona creation using the normalized attribute information.

As input, the server retrieves attribute records from the database, including age_group_code, occupation_code, thinking_style_code, hobby_codes, and region_code.

The server selects a persona-generation template based on the combination of codes and replaces template placeholders with corresponding human-readable values obtained from code tables.

The server concatenates template fragments into a single natural language prompt sentence and performs final text cleanup, such as ensuring proper line breaks and punctuation.

As output, the server produces a complete first prompt sentence ready to be transmitted to the generative AI model.

### Step 4

The server sends the first prompt sentence to the generative AI model and obtains persona information.

As input, the server provides the text of the first prompt sentence and model control parameters such as maximum token length and temperature.

The server issues an inference request either to a local inference engine or to a remote model service, which tokenizes the prompt, converts tokens to embeddings, and runs them through transformer layers to compute output token probabilities.

The generative AI model decodes a sequence of output tokens to form a natural language description of a virtual person, including background, lifestyle, values, and purchasing behavior.

The server receives this generated text as output and logs the request and response for traceability.

### Step 5

The server converts persona text into structured persona data and stores it.

As input, the server uses the generated persona description text obtained from the generative AI model.

The server applies pattern-based parsing rules and natural language processing techniques to split the text into sections corresponding to fields such as name, family situation, daily routine, main values, and consumption behavior.

The server maps extracted phrases into database fields, performs consistency checks, and resolves missing or ambiguous items by applying default values where appropriate.

As output, the server creates one or more persona records in the persona table, each linked to the corresponding attribute record via a foreign key.

### Step 6

The server generates a second prompt sentence for product evaluation for each persona.

As input, the server retrieves persona records and associated product design records from the database, including persona profile text segments and product feature descriptions.

The server selects an evaluation template and inserts persona profile fields into a persona section and product design fields into a product section of the template.

The server arranges information in a predetermined order that places key constraints and concerns before evaluation instructions, and then appends explicit questions about likes, dislikes, and desired improvements.

As output, the server produces a second prompt sentence tailored to each persona, ready for evaluation generation.

### Step 7

The server sends the second prompt sentence to the generative AI model and obtains evaluation information.

As input, the server provides each second prompt sentence together with model control parameters and, optionally, persona-and product-specific identifiers.

The server may batch multiple prompt sentences into a single inference call to the generative AI model, which processes the batch using parallel matrix operations on a graphics processing unit.

The generative AI model generates natural language evaluation texts describing, from each persona's viewpoint, positive aspects, negative aspects, and suggested improvements for the product design.

As output, the server receives one evaluation text per prompt sentence and associates each text with the corresponding persona and product design identifiers.

### Step 8

The server stores evaluation information in structured form.

As input, the server uses evaluation texts and metadata such as persona identifiers, product design identifiers, timestamps, and model versions.

The server performs basic text cleaning, such as removing extraneous spaces and normalizing line breaks, and splits the evaluations into sections based on question markers or headings.

The server inserts records into an evaluation table, storing full texts and, optionally, precomputed metrics such as sentiment scores or keyword counts for major features.

As output, the server maintains a structured repository of evaluation records that can be efficiently queried by persona, product design, or development stage.

### Step 9

The server aggregates evaluation information and computes analysis information.

As input, the server retrieves multiple evaluation records linked to a specific product design and, optionally, restricted to selected persona groups or process stages.

The server converts evaluation texts into feature vectors, where each dimension corresponds to a product feature or sentiment category, and then applies aggregation operations such as averaging, counting, and computing ratios.

The server identifies frequently mentioned positive and negative aspects, determines which features show strong or weak alignment with persona needs, and computes indicators of conformity to market requirements.

As output, the server generates analysis information, including summaries, statistics, and feature-level scores, and prepares a response payload containing this information for delivery to the terminal.

### Step 10

The terminal receives analysis information and evaluation details from the server and presents them to the user.

As input, the terminal obtains a structured response including persona identifiers, evaluation texts, and aggregated analysis metrics.

The terminal parses the response and renders user interface components such as lists of personas, associated comments, and graphical indicators of satisfaction or dissatisfaction for each feature.

The terminal allows the user to scroll, filter by persona type or feature, and select particular evaluations for closer inspection.

As output, the terminal displays visual and textual information to the user and generates user interaction events such as selections, highlights, and annotations for possible transmission back to the server.

### Step 11

The user interprets the displayed information and provides attention information or annotation information.

As input, the user views persona-based evaluations and aggregated analysis on the terminal display.

The user operates the terminal to mark important comments, add textual notes explaining why a comment is significant, or flag evaluations as particularly reliable or problematic.

The terminal records these interactions as structured annotation and attention data, associating them with evaluation identifiers and persona identifiers.

As output, the terminal transmits the annotation and attention data to the server for integration into further processing.

### Step 12

The server updates internal rules and prompt generation parameters based on user annotations and attention information.

As input, the server receives annotation and attention data that reference specific evaluation records and personas.

The server updates weight values and rule entries in configuration tables, for example increasing the priority of certain product features or concerns when constructing subsequent second prompt sentences.

The server may adjust template selection heuristics, reordering rules, or emphasis markers within prompt sentences to direct the generative AI model toward aspects that users have indicated as critical.

As output, the server maintains an updated rule set and parameter configuration that will influence future persona evaluations, improving focus and reducing redundant or low-value content.

### Step 13

The user revises product design information based on analysis and evaluation information.

As input, the user reviews technical and persona-based feedback displayed on the terminal and decides which design parameters require modification.

The user uses user interface controls on the terminal to change feature descriptions, adjust specifications, or modify design concepts.

The terminal collects the revised product design information and bundles it with a reference to the existing product design identifier.

As output, the terminal transmits an update request with the revised product design information to the server.

### Step 14

The server processes revised product design information and, if needed, initiates a new evaluation cycle.

As input, the server receives the updated product design payload and the identifier of the original design record.

The server creates a new version entry or updates existing records in the product design table and associates the revised design with the same or updated development-stage information.

The server decides, based on configuration or user request, whether to regenerate evaluations for existing personas by constructing new second prompt sentences reflecting the changes and sending them again to the generative AI model.

As output, the server stores new evaluation records and updated analysis information corresponding to the revised product design, supporting an iterative improvement process controlled by the server's structured data flows and rule-driven prompt generation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented techniques for supporting product planning, advertising design, and electronic commerce suffer from several technical limitations in how processors generate and use persona-based evaluations. In typical systems, a processor merely displays static survey results or simple rule-based segment information, and any persona description or feedback text must be manually authored by human operators. As a result, the processor does not dynamically generate prompt sentences tailored to a specific product, user attributes, or emotional states, and therefore cannot systematically leverage modern generative AI models to produce coherent, persona-based evaluation information at scale.

Moreover, existing systems generally treat a generative AI model as an external black box that simply returns text based on ad-hoc prompts entered by a user. The processor does not automatically analyze structured input data, does not construct prompt sentences in a consistent machine-controlled manner, and does not associate generated outputs with the underlying input conditions in a storage device. Consequently, it is difficult for the processor to perform reproducible analysis across multiple generative AI outputs, to compute trends or improvement indices, or to integrate persona-based evaluations into iterative product development flows as machine-processable data.

Further, known systems lack technical integration between emotion estimation models and generative AI models. Even when emotion-related data such as facial images, voice signals, or input patterns are available, typical processors neither estimate emotion states in a systematic way nor feed such emotion state information back into the construction of prompt sentences. Accordingly, the internal data processing pipeline of the processor cannot reflect emotional states in the generation of virtual entity information, which limits the depth and granularity of persona-based evaluations and restricts the practical utility of generative AI technology for computer-implemented product planning support.

In addition, conventional architectures often fail to maintain a structured linkage between the prompt sentences, the generated virtual entity information, the generated evaluation information, and the corresponding product target information. Without this linkage in a storage device, it is computationally expensive or practically impossible for the processor to apply statistical or machine learning techniques to a large set of persona-based evaluations, to automatically derive trends or improvement candidates, or to present such results back to client devices in a consistent and efficient manner.

Accordingly, there is a need for an improved computer-implemented system in which a processor is configured to (i) acquire target information and user attribute information, (ii) generate and manage structured prompt sentences for a generative AI model, (iii) generate virtual entity information and evaluation information in a reproducible and analyzable manner, (iv) integrate emotion state estimation into the prompt generation process, and (v) store all related information in association so that the processor can later perform automated analysis. Such a configuration improves the overall operation of the computer system by enabling more effective utilization of generative AI models, reducing manual intervention, and providing a technically advantageous data processing pipeline for persona-based product planning and evaluation.

The specific processing by the specific processing unit 290 of the data processing device 12 in Application Example 2 is realized by the following means.

The present invention provides a server comprising a processor and a storage device, the processor being configured to acquire, via a communication network, target information and user attribute information from a user information processing apparatus; to analyze the target information and the user attribute information and convert the analyzed information into structured data; to construct, based on the structured data, a prompt sentence including the user attribute information; to input the prompt sentence to a generative information processing model so as to cause the generative information processing model to generate virtual entity information; to construct and input another prompt sentence to the generative information processing model so as to cause the generative information processing model to generate evaluation information on the target information based on the virtual entity information; to acquire emotion-related data from the user information processing apparatus, input the emotion-related data to an emotion estimation model to estimate user emotion state information, and integrate the user emotion state information with the user attribute information when constructing the prompt sentence for generating the virtual entity information; to store, in the storage device, the prompt sentence, the virtual entity information, the evaluation information, and the target information in association with one another; and to analyze, by a statistical method or a machine learning method, a plurality of pieces of the virtual entity information and the evaluation information stored in the storage device to generate trend information or improvement candidate information and to provide the evaluation information, the trend information, or the improvement candidate information to the user information processing apparatus. This enables the computer system to automatically generate and manage persona-based evaluation information through coordinated use of a generative AI model and an emotion estimation model, to maintain machine-readable associations between prompts, virtual entities, evaluations, and target information, and to perform efficient, automated analysis of multiple generative outputs, thereby improving the technical capabilities of the server in supporting product planning, advertising design, and electronic commerce.

The term “system” refers to an information processing arrangement including at least one processor and at least one storage device, and optionally including one or more communication interfaces for exchanging data with external apparatuses over a communication network.

The term “processor” refers to a hardware processing unit, such as a central processing unit, a graphics processing unit, or another arithmetic processing circuit, configured to execute computer-readable instructions and perform data processing operations as described herein.

The term “storage device” refers to a non-transitory computer-readable medium, such as a semiconductor memory, a magnetic storage medium, or an optical storage medium, configured to store programs, parameters, and data including prompt sentences, virtual entity information, evaluation information, and target information.

The term “communication network” refers to a wired or wireless data communication infrastructure, such as a local area network, a wide area network, or a public network, through which digital information is transmitted between the system and external apparatuses.

The term “user information processing apparatus” refers to an electronic client device, such as a personal computer, a tablet terminal, or a mobile communication terminal, that is operated by a user and configured to transmit input information and receive output information via the communication network.

The term “target information” refers to information representing an object of evaluation or planning, such as information about a product, a service, a prototype, an advertisement, or a concept, which is to be analyzed or improved by using the system.

The term “user attribute information” refers to information indicating characteristics of a user or a target group, such as an age range, a thinking tendency, an interest field, or other demographic or psychographic attributes, which are used to define a virtual entity.

The term “prompt sentence” refers to a text string or other structured input data generated by the processor and provided to a generative information processing model in order to specify a requested operation or content generation condition for that model.

The term “generative information processing model” refers to a trained computational model, such as a generative AI model based on a neural network, configured to generate new information including text, profiles, or evaluations in response to an input prompt sentence.

The term “virtual entity information” refers to information representing a fictitious persona or user-like profile that is generated by the generative information processing model based on the prompt sentence and that includes at least one attribute such as age, tendency, or interest.

The term “evaluation information” refers to information generated by the generative information processing model indicating an opinion, assessment, or feedback with respect to the target information from a viewpoint of the virtual entity information.

The term “emotion-related data” refers to data obtained from the user information processing apparatus that is indicative of a user's emotional state, including but not limited to image data of a facial expression, audio data of speech, or behavioral data such as input timing patterns.

The term “emotion estimation model” refers to a trained computational model configured to receive emotion-related data and output user emotion state information by performing pattern recognition or inference processing.

The term “user emotion state information” refers to information representing an estimated emotional condition of a user, such as calmness, excitement, curiosity, or anxiety, derived from emotion-related data by the emotion estimation model.

The term “structured data” refers to data that has been converted by the processor into a predefined format, such as a table, a record set, or a key-value structure, enabling systematic processing, analysis, and prompt sentence generation.

The term “statistical method” refers to a computational technique based on statistics, such as aggregation, clustering, regression, or frequency analysis, used by the processor to analyze multiple pieces of virtual entity information and evaluation information.

The term “machine learning method” refers to a computational technique in which a model is trained using data so that the model can infer patterns or predictions, and which is used by the processor to analyze virtual entity information and evaluation information.

The term “trend information” refers to information indicating patterns, tendencies, or common characteristics extracted from a plurality of pieces of virtual entity information and evaluation information with respect to the target information.

The term “improvement candidate information” refers to information specifying proposed modifications or enhancements to the target information, derived from analysis of the virtual entity information and the evaluation information.

The term “planning work” refers to computer-supported activities related to designing, configuring, or improving products, services, or advertisements, which are performed by a user using information provided by the system.

The term “product development person” refers to an individual or a group engaged in planning, designing, or improving a product or service, who receives evaluation information, trend information, or improvement candidate information via the user information processing apparatus.

In one embodiment, a server implements a system for generating persona-based evaluation information using a generative AI model and an emotion estimation model. The server includes at least one processor, at least one storage device, and at least one communication interface coupled to a communication network. A terminal, such as a personal computer, a tablet device, or a mobile communication device, is operated by a user and communicates with the server. The user, the terminal, and the server cooperate to realize the functions recited in the claims.

The server executes an operating system such as a general-purpose server operating system and application software implemented, for example, in a programming language such as Python or similar. The server stores, in the storage device, executable instructions, model parameters for a generative AI model, model parameters for an emotion estimation model, and data structures for storing prompt sentences, virtual entity information, evaluation information, and target information. The server uses a database management system, such as a relational database system, to store these data structures in tables with predefined schemas.

The terminal executes a client-side program, such as a web browser or a native application, that renders input forms and output screens. The terminal presents graphical user interface elements for inputting target information and user attribute information, and for optionally capturing emotion-related data such as facial images and voice signals. The terminal transmits these data to the server via the communication network using a network protocol such as HTTPS.

The user inputs, through the terminal, target information that describes an object of evaluation or planning. The target information may include, for example, a product description, a prototype specification, or an advertisement concept. The user further inputs user attribute information, including, for example, age range, thinking tendency, hobby information, and other demographic or psychographic attributes that are relevant to defining a persona or virtual entity. The user may grant permission for the terminal to activate a camera and a microphone to capture emotion-related data.

The terminal captures emotion-related data by controlling hardware sensors. The terminal controls an image sensor to capture frames of the user's face and compresses them into image data, such as in a compressed image format. The terminal controls an audio input device to record voice of the user and encodes the audio stream into a digital audio file. The terminal can also record interaction behavior, such as keystroke timing information, pointer movement statistics, and scrolling speed, and can include such behavioral signals as part of the emotion-related data. The terminal transmits the target information, the user attribute information, and the emotion-related data to the server in structured messages over the communication network.

The server receives the transmitted data via the communication interface and stores the raw data in the storage device in association with a request identifier. The server parses the received data using a parsing module and transforms the target information and the user attribute information into structured data. For example, the server maps free-text fields of the target information into key-value pairs, such as “product_name,” “target_age_range,” “feature_list,” and the like. The server normalizes and encodes these fields into data structures suitable for subsequent processing.

The server implements an emotion estimation model using a machine learning framework such as a numerical computation library. In one example, the emotion estimation model includes a convolutional neural network for processing facial image data, a recurrent or transformer-based network for processing audio data, and a statistical or neural component for processing behavioral signals. The server extracts, from the image data, facial regions and facial landmarks by applying image preprocessing operations such as resizing, color normalization, and face detection. The server then computes feature maps using convolutional layers whose weights have been pre-trained on facial expression datasets. In parallel, the server computes acoustic features such as mel-frequency cepstral coefficients from the audio data and processes these features using a sequence model to detect prosody and tone. The server also aggregates behavioral features such as typing rhythm and pointer velocity.

The server fuses these features into a joint feature vector and applies one or more fully connected layers to output probabilities for discrete emotion categories or continuous scores along emotion dimensions. The server uses an error function, such as cross-entropy loss for discrete categories or mean squared error for continuous values, during an offline training process to update the model weights by gradient descent or similar optimization methods. The server stores the trained weights in the storage device and loads them into memory at runtime. When deployed, the server uses the trained emotion estimation model to infer user emotion state information, such as “calm,” “excited,” or “curious,” from the incoming emotion-related data.

The server integrates the inferred user emotion state information with the user attribute information to construct a persona attribute vector. The persona attribute vector may include fields that represent age range, thinking tendency, hobby categories, and emotion state scores. The server stores this persona attribute vector in the database in association with the request identifier and the target information.

The server then constructs at least one prompt sentence for a generative AI model. The generative AI model can be, for example, a transformer-based large language model whose architecture consists of multiple layers of self-attention and feed-forward networks. The model is pre-trained on large-scale text corpora using an unsupervised learning objective, such as predicting next tokens, and optionally fine-tuned on instruction-following tasks. The server maintains a prompt-generation module that applies rule-based templates and transformation logic to structured data instead of relying solely on arbitrary user-entered text. The prompt-generation module reads the persona attribute vector and the target information and fills template slots to generate a controlled prompt sentence.

For example, the server can generate a prompt sentence as follows:

“The prototype of a new smartphone targeting people in their 20s has been completed. From the viewpoint of a 25-year-old male university student who is highly interested in technology, please generate detailed feedback on this smartphone, including both strengths and weaknesses.”

In another example, the server can generate a prompt sentence for persona creation rather than immediate evaluation:

“Please generate a detailed persona for outdoor products aimed at men in their 20s who are budget-conscious. Include age, occupation, hobbies, income level, purchase channels, and typical concerns when buying outdoor gear.”

In a further example, the server can generate a prompt sentence that explicitly reflects the emotion state:

“From the viewpoint of a conservative book lover in his 30s, who is in a calm emotional state and values stability and reliability, please generate opinions about a new e-book reader, focusing on usability, display quality, and long-term comfort.”

The server constructs these prompt sentences as text strings, embeds structured persona attributes and target information directly into the text, and logs both the structured data and the final generated text into the database.

The server inputs the constructed prompt sentence into the generative AI model by passing the text to a model interface module. Internally, the generative AI model tokenizes the prompt sentence into subword units, maps the tokens to embeddings, applies multiple layers of self-attention and feed-forward transformations, and computes probability distributions over output tokens. The server configures model parameters such as temperature, top-k sampling, or beam width to control output diversity and determinism. The generative AI model then generates output text tokens one by one based on the computed probabilities and decoding strategy. The server assembles these tokens into a coherent output sequence, which constitutes virtual entity information, evaluation information, or both.

When the server asks the generative AI model to generate virtual entity information, the prompt sentence focuses on constructing a persona profile. When the server asks the generative AI model to generate evaluation information, the prompt sentence explicitly instructs the model to produce opinions or feedback from the perspective of a previously generated virtual entity. The server can combine these calls in sequence, first obtaining the virtual entity information and then using that virtual entity information as context for an evaluation-oriented prompt sentence.

The server receives the generative AI model's output and parses it into structured fields when possible. For example, the server can detect sentences describing strengths, weaknesses, usage scenarios, or concerns by using keyword patterns, regular expressions, or a lightweight classifier. The server stores the generated virtual entity information and the generated evaluation information in the database in association with the original target information, the persona attribute vector, and the corresponding prompt sentences. The server thus creates a linked dataset that captures the mapping from structured inputs (target information, user attribute information, emotion state) to generated outputs (virtual entity information and evaluation information).

The server performs statistical or machine learning analysis on multiple pieces of stored virtual entity information and evaluation information. The server can, for example, vectorize evaluation texts using text embedding models and perform clustering to identify recurring patterns of praise or criticism across different target information. The server can also compute frequencies of particular feature-related terms, average sentiment scores for each product feature, or correlations between emotion states and evaluation strength. By operating on the structured linkage between prompt sentences, virtual entity information, evaluation information, and target information, the server reduces the computational burden and avoids repeated parsing of unstructured text from scratch.

The server provides analysis results, such as trend information or improvement candidate information, to the terminal. The terminal renders these results in a user interface that highlights commonly requested improvements or salient persona-based reactions. The user interprets these results and can modify the target information or design choices accordingly.

This architecture yields several technical effects that go beyond a simple automation of human tasks. Because the server encodes user attribute information and emotion state information into a structured persona attribute vector and uses rule-based templates to construct prompt sentences, the server ensures consistent prompting across a large number of requests. This reduces variance in model outputs attributable to uncontrolled prompt variations and improves the accuracy and reproducibility of persona-based evaluations. The explicit storage of prompt sentences together with structured inputs and outputs in the database allows the server to reuse or refine prompt sentences for similar target information, thereby reducing communication overhead and computation required for repeated experimentation.

By applying an emotion estimation model based on neural network architectures to sensor data from the terminal, the server introduces additional feature dimensions that are impractical for manual human analysis and uses them to control generative AI behavior. This technical integration of multimodal emotion features with structured text generation improves the representational richness of the generated virtual entity information and evaluation information, leading to more fine-grained and technically actionable patterns in subsequent statistical or machine learning analysis. The server thereby improves data management by associating the richer feature space with the generated content, enabling more advanced indexing, retrieval, and aggregation operations than conventional systems.

Furthermore, the server uses specific internal algorithms, such as neural network models with pre-defined architectures, error functions, and optimization methods, rather than relying on unspecified “AI processing.” The server controls the generative AI model via computed prompt sentences in a systematic, machine-generated manner, which constitutes a non-conventional use of generative AI technology. In particular, the server employs a non-standard rule set for prompt construction, which enforces the inclusion of specific structured elements such as emotion state labels, demographic ranges, and feature lists. These elements enable the generative AI model to produce outputs that can be directly aligned with database schemas and analyzed programmatically. This systematic and constrained usage differs from human operators casually entering prompts and instead represents a technical configuration of data structures and processing steps that improves the functioning of the computer system handling persona-based evaluations.

In addition, the linked storage of prompt sentences, persona attributes, and resulting evaluations allows the server to perform incremental learning, such as updating or refining statistical models that predict which prompts yield the most discriminative feedback for a given category of target information. The server can reduce computation by reusing cached evaluations for similar personas or by narrowing down required generative calls based on prior patterns. In this way, the server decreases communication load to remote model endpoints and lowers average response times.

In alternative embodiments, the server can locally host the generative AI model and/or the emotion estimation model on one or more hardware accelerators. The server can use different neural network architectures, such as recurrent neural networks, convolutional networks for text, or hybrid models, and can adopt different learning schemes, such as supervised fine-tuning on domain-specific corpora or reinforcement learning for prompt selection. The server can modify the specific feature extraction pipeline for emotion-related data, for example by including heart rate or other physiological signals captured by additional sensors connected to the terminal.

In another embodiment, the server can tailor the generative AI model outputs to control external devices. For example, the server can analyze evaluation information to automatically adjust parameter settings of a prototype device, such as a screen brightness level, vibration feedback, or audio volume, in a simulation environment. The server can thereby close a loop in which persona-based evaluations are used to automatically update device configuration presets, which can then be tested physically. This technical use of generated evaluation information demonstrates that the system is not limited to abstract business planning, but supports concrete configuration and control of technical apparatuses.

In yet another embodiment, the server supports multiple user information processing apparatuses concurrently and manages parallel processing of prompt sentences and model inferences. The server implements request scheduling and batching strategies that combine several prompt sentences into a single batch inference call to the generative AI model, thereby improving computational efficiency and throughput. The server can dynamically adjust batching sizes or decoding parameters depending on current system load, thus optimizing resource utilization.

Through these embodiments, the server, the terminal, and the user cooperate to implement the claimed system. The server improves internal computer operations by enforcing structured data flows, by integrating multimodal emotion estimation with generative AI prompting, and by storing and analyzing linked input-output tuples in a database. These technical arrangements, in combination, provide enhanced processing speed, improved accuracy, and more efficient data management compared to conventional systems that merely automate human text entry or manual persona definition.

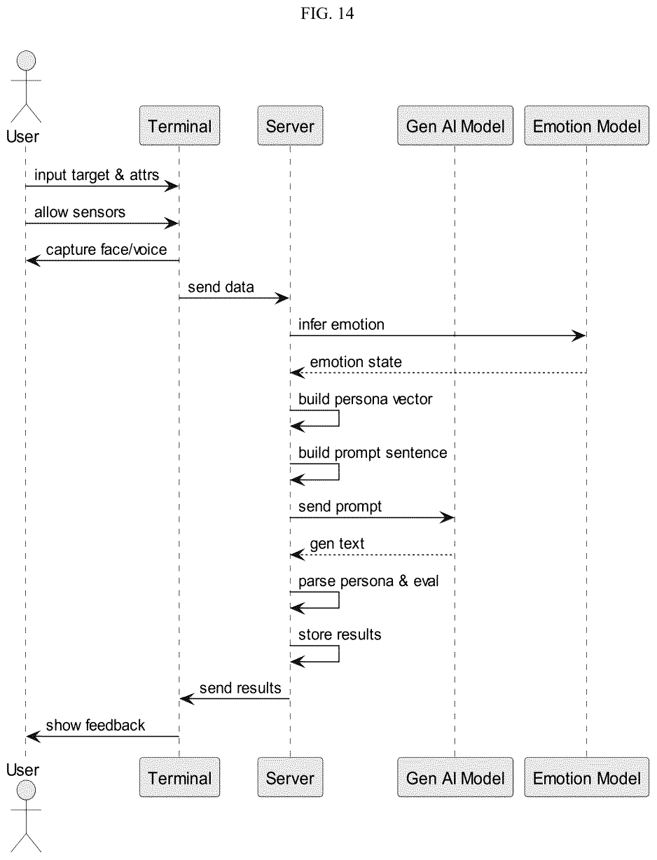

The following describes the processing flow using FIG. 14.

### Step 1

The user operates the terminal to input target information and user attribute information. The user enters, as input, product or service descriptions (target information) and persona-related items such as age range, thinking tendency, and hobbies (user attribute information) into form fields displayed on the terminal. The terminal receives these values, converts them into a structured internal representation (for example, a key-value map or JSON object), and sets this structured object as output to be transmitted to the server.

### Step 2

The terminal captures emotion-related data under control of the user. The terminal receives, as input, the user's permission to access hardware sensors such as a camera and a microphone, and then activates these devices. The terminal captures video frames of the user's face and audio samples of the user's voice, and records interaction behavior such as keystroke timings. The terminal performs local data processing, such as compressing images, encoding audio, and aggregating timing intervals into vectors, to produce a compact emotion-related data set as output. The terminal bundles this emotion-related data set together with the structured target information and user attribute information and sends them as output over a communication network to the server.

### Step 3

The server receives and stores the raw input data. The server accepts, as input, the structured target information, the user attribute information, and the emotion-related data transmitted from the terminal via a communication interface. The server parses the incoming message, validates required fields, and assigns a unique request identifier. The server performs data conversion operations, such as parsing text into fields, normalizing character encodings, and converting timestamps into a unified time format. The server then stores these parsed and normalized data objects into records of a database table as output, associating them with the request identifier for later retrieval.

### Step 4

The server executes the emotion estimation model to infer user emotion state information. The server retrieves, as input, the emotion-related data corresponding to the request identifier from the database, including facial images, audio segments, and behavior logs. The server applies preprocessing operations: resizing and normalizing image pixels, extracting acoustic feature vectors (such as mel-frequency cepstral coefficients) from audio, and converting behavior logs into fixed-length numerical feature vectors. The server inputs these feature tensors into an emotion estimation model implemented as a neural network, executes matrix multiplications, activation functions, and normalization operations, and computes probability scores for multiple emotion categories. The server determines an emotion label or a set of emotion scores (user emotion state information) from the maximum probability or thresholding. The server outputs the user emotion state information and stores it in the database linked to the request identifier.

### Step 5

The server constructs a persona attribute vector by combining user attributes and emotion state. The server takes, as input, the user attribute information and the user emotion state information associated with the request. The server performs data fusion by mapping discrete items such as age range, thinking tendency, and hobbies into categorical codes, and by mapping emotion labels into one-hot or continuous-valued vectors. The server concatenates or otherwise combines these vectors into a single structured persona attribute vector. The server outputs this persona attribute vector and writes it into a dedicated persona table in the database, linked to the target information and the request identifier.

### Step 6

The server generates a prompt sentence for a generative AI model based on the persona attribute vector and the target information. The server reads, as input, the persona attribute vector and the target information for the current request. The server applies template-based string generation logic, which selects a template according to the processing purpose (persona generation or evaluation generation) and fills placeholder positions with text converted from the structured attributes. For example, the server converts age range and hobby codes into natural language phrases and embeds them into a sentence structure. The server concatenates static text segments with dynamic attribute-derived text segments to form a coherent prompt sentence. The server outputs the prompt sentence as a text string and stores it in the database for traceability.

### Step 7

The server calls the generative AI model using the constructed prompt sentence. The server uses, as input, the prompt sentence generated in Step 6 and model configuration parameters such as maximum token count and sampling temperature. The server constructs an API request payload, including the prompt sentence and configuration parameters, and sends this payload to the generative AI model endpoint over a communication network. Internally, the generative AI model tokenizes the prompt sentence and processes it with a transformer-based architecture to compute output token probabilities. The server receives as output from the generative AI model a sequence of tokens representing generated text, which is then reassembled into a full text output. The server stores this raw generated text in the database associated with the prompt sentence and the persona attribute vector.

### Step 8

The server separates and structures the generated virtual entity information and evaluation information. The server uses, as input, the generated text returned by the generative AI model. The server applies parsing rules and pattern matching (for example, keyword detection or section markers) to identify segments describing persona details (virtual entity information) and segments describing opinions or feedback (evaluation information). The server may execute text segmentation, sentence classification, and regular expression matching to map segments to predefined fields such as “strengths,” “weaknesses,” and “usage scenarios.” The server outputs structured virtual entity information and structured evaluation information and writes them into corresponding database tables linked to the original prompt sentence and target information.

### Step 9

The server performs statistical or machine learning analysis on stored virtual entity information and evaluation information. The server collects, as input, multiple records of virtual entity information and evaluation information stored in the database across many requests. The server converts text fields into numerical feature vectors using embedding models or bag-of-words representations and retrieves numerical persona attributes from the persona attribute vectors. The server applies analytical algorithms such as clustering, regression, or frequency analysis to compute trends, correlations, and common patterns. As output, the server generates trend information (for example, frequently mentioned criticisms about battery life) and improvement candidate information (for example, recommended feature adjustments), and stores these results in analysis result tables.

### Step 10

The server sends structured outputs to the terminal for presentation to the user. The server retrieves, as input, the structured virtual entity information, the structured evaluation information, and, when available, the trend information or improvement candidate information corresponding to the current request or to a selected set of requests. The server formats these data objects into a response payload suitable for client display, such as a JSON document with labeled fields. The server outputs the formatted data by transmitting the response to the terminal over the communication network.

### Step 11

The terminal renders the persona-based feedback and analysis results to the user. The terminal accepts, as input, the response payload from the server that contains persona summaries, evaluation details, and trend or improvement information. The terminal parses the payload and performs UI generation operations, such as creating panels for persona attributes, listing textual feedback sections, and visualizing trends in charts or tables. The terminal outputs a graphical display on its screen showing the persona attributes, the feedback text, and any suggested improvements. The user reads these outputs, interprets the results, and can use them as input for further refinement of target information in subsequent interactions with the system.

### Step 12

The user iteratively refines the target information based on the displayed results. The user observes, as input, the persona-based evaluation information and any trend or improvement candidate information shown by the terminal. The user identifies concrete issues or opportunities (such as missing features or confusing design elements) and edits the target information accordingly through the terminal's input interface. The user then initiates a new request, which becomes output in the form of updated target information and user attribute information transmitted to the server, thereby starting a new processing cycle that repeats the preceding steps with refined data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

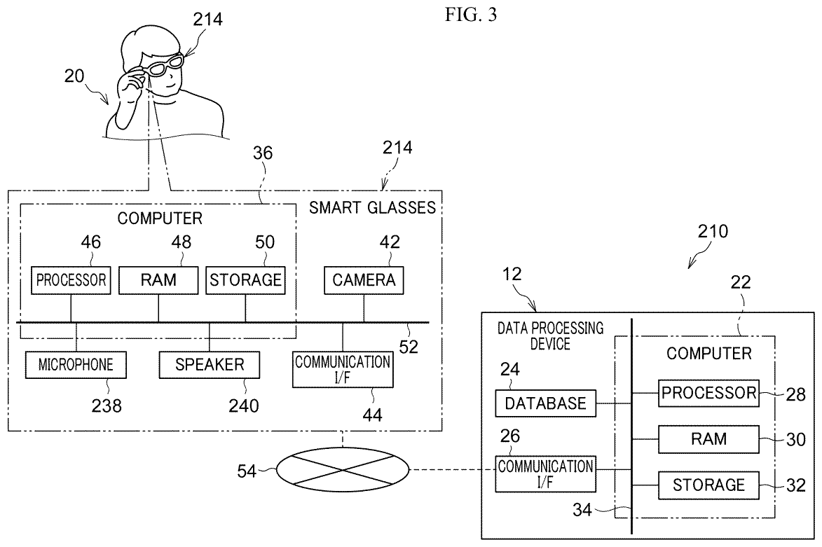

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

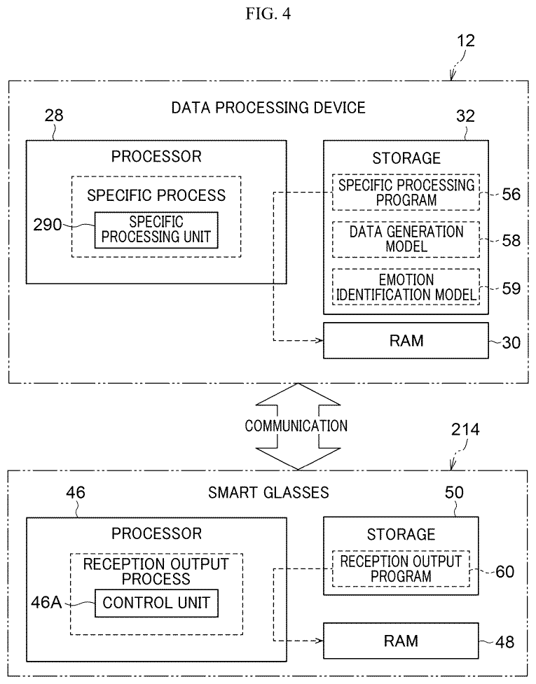

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

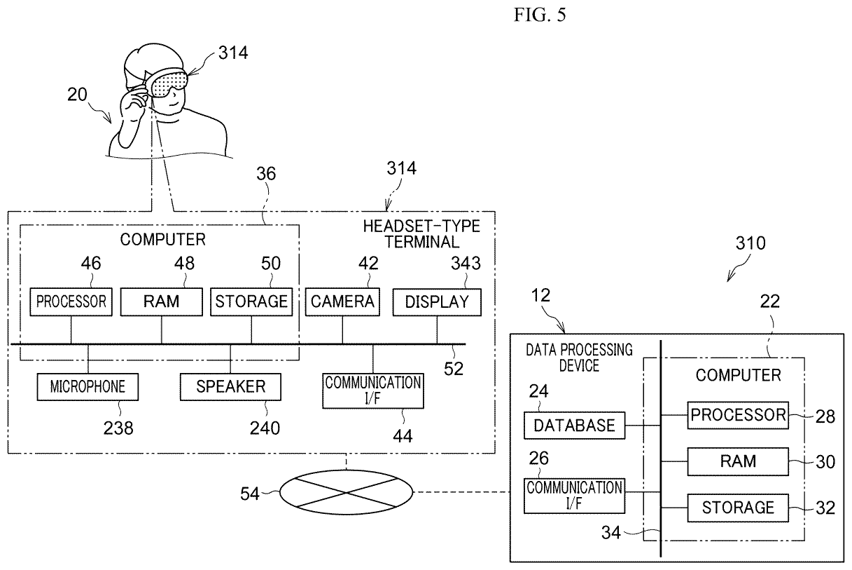

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

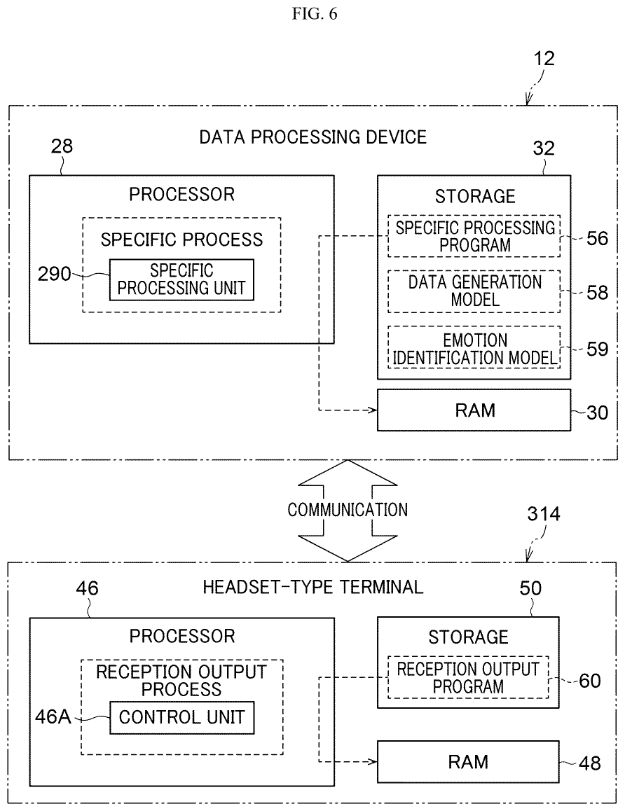

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

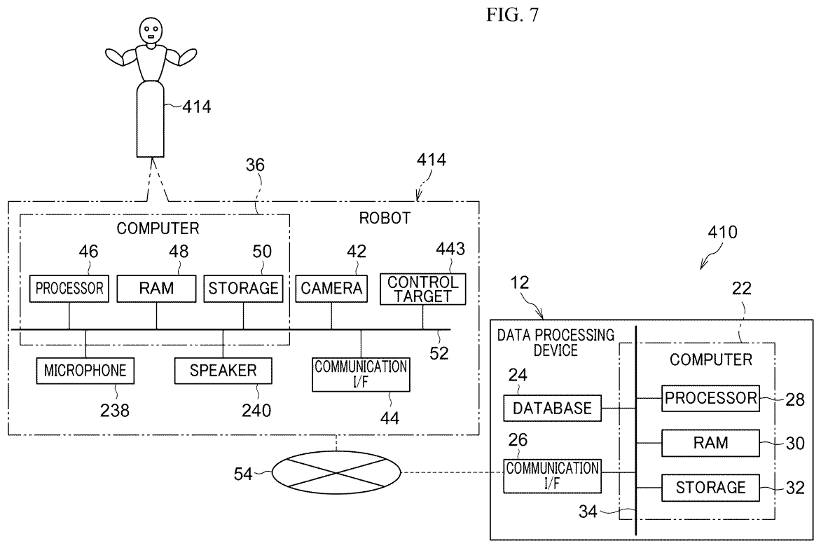

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

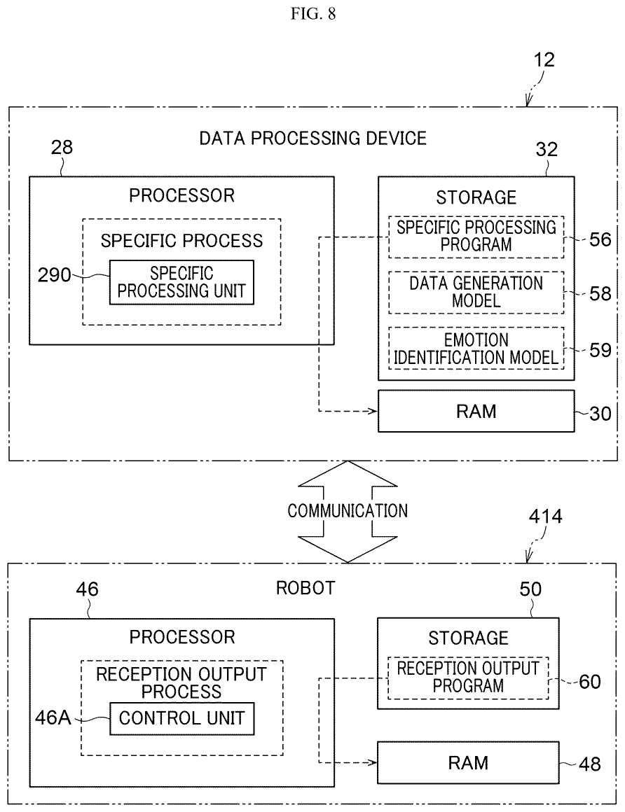

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

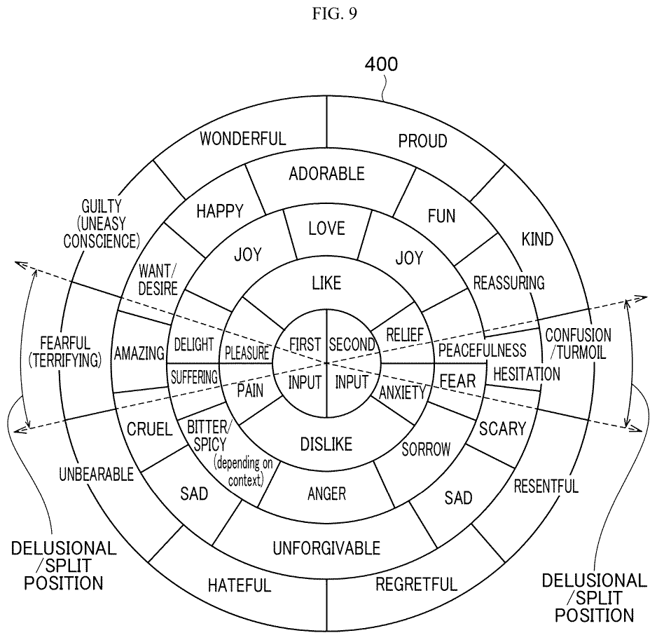

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

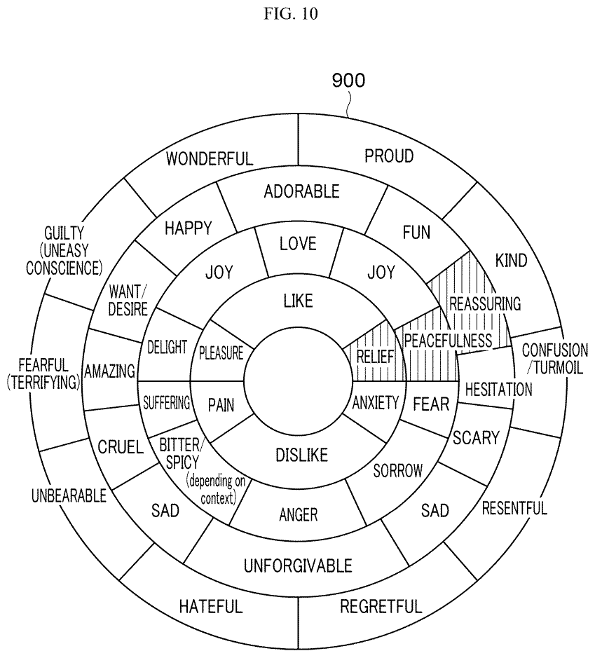

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a communication interface, input information including attribute information comprising at least an age range, a thinking tendency, and a preference from a user terminal, analyze the received input information and construct, by applying the input information to a natural language template, a prompt sentence as instruction information that directs a generative AI model to generate persona information,
transmit, via a communication interface, generation request data including the constructed prompt sentence to the generative AI model disposed externally or internally to the system, and obtain, from the generative AI model, text data as persona information generated by natural language processing performed by the generative AI model based on the prompt sentence,
classify the obtained persona information in accordance with a usage mode for planning, designing, or evaluating a product or a service, and organize the persona information into background information, values information, behavioral characteristic information, and purchasing behavior information,
store the organized persona information in a storage unit, generate response data including the persona information or opinion information based on the persona information, and transmit the response data to the user terminal operated by a product development operator so that the persona information is displayable and referable in respective stages of product development on the user terminal.

### Supplementary 2

The system according to supplementary 1,
wherein the processor is configured to
detect a missing item or an inconsistent item in the received input information, perform completion or correction of the missing item or the inconsistent item based on predefined attribute candidates, and thereafter generate the prompt sentence so as to clarify persona generation conditions for the generative AI model.

### Supplementary 3

The system according to supplementary 1,
wherein the processor is configured to
generate additional prompt sentences based on the persona information, transmit, to the generative AI model, additional input data including the additional prompt sentences that inquire evaluation content with respect to specification proposals, function proposals, or price proposals of the product or the service, obtain, from the generative AI model, the evaluation content, and classify and provide the evaluation content to a product development team in association with respective examination stages of product development.

### Application Example 1

### Supplementary 1

A system comprising a processor,
wherein the processor is configured to receive input information including attribute information from a user terminal, analyze the input information, and construct text data including the attribute information so as to generate a prompt sentence for a generative AI model,
wherein the processor is configured to input the generated prompt sentence into the generative AI model by converting the prompt sentence into a sequence of tokens, executing numerical computation processing using the sequence of tokens to cause generation of response text data indicating a virtual person, and extract attributes of the virtual person from the response text data so as to generate persona data, and
wherein the processor is configured to store the generated persona data as structured data, generate analysis result data including product specification information and strategy information related to advertising activities on the basis of the persona data, and output the analysis result data in a format usable for product development and advertising planning.

### Supplementary 2

The system according to supplementary 1,
wherein the processor is configured to generate an additional prompt sentence for the generative AI model on the basis of the persona data and the analysis result data, input the additional prompt sentence into the generative AI model, cause generation of text data indicating an advertising strategy proposal corresponding to the persona data, and provide the advertising strategy proposal to the user terminal.

### Supplementary 3

The system according to supplementary 1,
wherein the processor is configured to analyze the response text data indicating the virtual person output from the generative AI model, extract a plurality of attribute elements including value information, behavioral pattern information, and information acquisition channel information, calculate characteristic indices of a target group using the plurality of attribute elements, and automatically recommend improvement proposals for product specifications and selection proposals for advertising media using the characteristic indices.

### Example 2

### Supplementary 1

A system comprising a processor,
wherein the processor is configured to
receive input information including attribute information and product design information from a user, store the input information in storage information, and perform normalization and validation of the input information,
generate a first prompt sentence for input to a generative AI model using natural language processing technology based on the attribute information, input the first prompt sentence to the generative AI model to cause the generative AI model to generate persona information including a plurality of virtual person information, convert the persona information output from the generative AI model into structured data, and store the structured data in the storage information,
generate, based on the product design information and the persona information stored in the storage information, a second prompt sentence for obtaining product evaluation from viewpoints of respective personas, input the second prompt sentence to the generative AI model to cause the generative AI model to generate evaluation information corresponding to the respective personas, and store the evaluation information output from the generative AI model in association with the storage information, and
aggregate a plurality of pieces of evaluation information stored in the storage information, generate analysis information indicating at least one of a degree of conformity to market requirements and improvement points based on a relationship between the evaluation information and the product design information, and provide information usable for improvement of product design by outputting the analysis information to a terminal.

### Supplementary 2

The system according to supplementary 1,
wherein the processor is configured to
analyze the attribute information and the product design information acquired from the user, perform at least word unification and classification assignment on the attribute information, perform division and feature extraction for each functional item on the product design information, and automatically adjust wording structure of at least one of the first prompt sentence and the second prompt sentence based on analysis results.

### Supplementary 3

The system according to supplementary 1,
wherein the processor is configured to
manage the persona information and the evaluation information stored in the storage information in association with process information of product development, extract the evaluation information of the personas corresponding to each process and present the evaluation information to the terminal, record, in association with the evaluation information, at least one of attention information and annotation information by the user, and, based on a result of the recording, generate the prompt sentence for the generative AI model again and repeatedly update the evaluation information.

### Application Example 2

### Supplementary 1

A system comprising a processor,
wherein the processor is configured to
acquire, via a communication network, target information and user attribute information that are input by a user through a user information processing apparatus,
construct a prompt sentence including the user attribute information based on the target information and the user attribute information, and input the prompt sentence to a generative information processing model so as to cause the generative information processing model to generate virtual entity information,
input, to the generative information processing model, a prompt sentence so as to cause the generative information processing model to generate evaluation information on the target information based on the virtual entity information,
output the evaluation information to the user information processing apparatus so that the evaluation information is usable for planning work related to the target information, acquire emotion-related data from the user information processing apparatus, input the emotion-related data to an emotion estimation model to estimate user emotion state information, and construct the prompt sentence for generating the virtual entity information by integrating the user emotion state information with the user attribute information, and store, in a storage device, the prompt sentence, the virtual entity information, the evaluation information, and the target information in association with one another so that the evaluation information is analyzable as an improvement index for the target information.

### Supplementary 2

The system according to supplementary 1,
wherein the processor is configured to analyze the target information and the user attribute information acquired from the user information processing apparatus, convert the analyzed information into structured data, and generate the prompt sentence to be input to the generative information processing model based on the structured data.

### Supplementary 3

The system according to supplementary 1,
wherein the processor is configured to analyze, by a statistical method or a machine learning method, a plurality of pieces of the virtual entity information and the evaluation information stored in the storage device, generate trend information or improvement candidate information related to the target information, and provide the trend information or the improvement candidate information to a product development person via the user information processing apparatus.

What is claimed is:

1. A system comprising:
circuitry configured to:
receive, via a communication interface coupled to a packet-switched network, attribute data from a terminal device;
normalize the attribute data by detecting missing or inconsistent items and performing completion or correction based on predefined attribute candidates to obtain normalized attribute data;
generate, by applying the normalized attribute data to a natural language template, a first prompt and transmit the first prompt to a generative neural network model to obtain profile data generated by the generative neural network model;
classify the profile data into a plurality of predefined categories and store the classified profile data in a storage device in association with the normalized attribute data;
generate a second prompt based on at least a portion of the classified profile data, transmit the second prompt to the generative neural network model, and acquire evaluation output data from the generative neural network model; and
transmit response data including the classified profile data and the evaluation output data to the terminal device via the communication interface.

2. The system according to claim 1, wherein the circuitry is further configured to normalize the attribute data by mapping free-form text entries to canonical internal values using at least one of string matching, tokenization, and distance computation between tokens and candidate terms stored in a mapping table.

3. The system according to claim 2, wherein the circuitry is further configured to estimate missing attribute values by referencing correlations between existing attributes stored from prior processing records and inserting default values based on statistical distributions.

4. The system according to claim 3, wherein the attribute data includes at least an age range, a thinking tendency, and a preference, and wherein the natural language template includes slots corresponding to the age range, the thinking tendency, and the preference.

5. The system according to claim 4, wherein the profile data comprises persona information describing a virtual person, and wherein the plurality of predefined categories comprise background information, values information, behavioral characteristic information, and purchasing behavior information.

6. The system according to claim 1, wherein the generative neural network model comprises a transformer architecture including an embedding layer, a plurality of self-attention layers, feed-forward layers, and an output projection layer.

7. The system according to claim 6, wherein the circuitry is further configured to convert the first prompt into a sequence of tokens using a subword tokenizer, construct a numerical tensor representation from the sequence of tokens, and execute the generative neural network model by performing matrix multiplications and non-linear activation operations on the numerical tensor representation.

8. The system according to claim 7, wherein the generative neural network model is trained by minimizing a cross-entropy loss between predicted token distributions and ground-truth tokens using gradient-based optimization with an adaptive learning rate algorithm.

9. The system according to claim 1, wherein the circuitry is further configured to classify the evaluation output data by associating the evaluation output data with a stage label selected from a plurality of predefined stage labels based on predefined mappings.

10. The system according to claim 9, wherein the plurality of predefined stage labels correspond to stages of a development process including concept planning, feature refinement, and evaluation phases.

11. The system according to claim 10, wherein the circuitry is further configured to iteratively generate updated second prompts based on annotation data or attention indication data received from the terminal device, and to regenerate the evaluation output data by repeated invocation of the generative neural network model.

12. The system according to claim 1, wherein the circuitry is further configured to classify the profile data by applying at least one of pattern-based extraction using section markers embedded in the first prompt and a text classification model to allocate portions of the profile data into the plurality of predefined categories.

13. The system according to claim 12, wherein the circuitry is further configured to store the classified profile data in a database using a schema that associates each profile record with the normalized attribute data, the first prompt, and category-specific fields indexed for retrieval.

14. The system according to claim 1, wherein the circuitry is further configured to aggregate a plurality of pieces of stored evaluation output data and compute analysis information indicating at least one of characteristic indices, frequency counts, and sentiment scores across a plurality of profile records.

15. The system according to claim 14, wherein the circuitry is further configured to generate recommendation data including specification improvement information and strategy information based on the analysis information and the characteristic indices.

16. The system according to claim 1, wherein the circuitry is further configured to acquire emotion-related data from the terminal device, input the emotion-related data to an emotion estimation model comprising a neural network, and estimate emotion state information.

17. The system according to claim 16, wherein the circuitry is further configured to integrate the emotion state information with the attribute data when generating the first prompt, thereby reflecting the estimated emotion state in the profile data generated by the generative neural network model.

18. A system comprising:
circuitry configured to:
receive, via a communication interface coupled to a packet-switched network, attribute data including an age range, a thinking tendency, and a preference from a terminal device, and normalize the attribute data by mapping free-form text entries to canonical internal values using string matching and distance computation against predefined attribute candidates stored in a mapping table;
generate, by applying the normalized attribute data to a natural language template having slots for the age range, the thinking tendency, and the preference, a first prompt, convert the first prompt into a sequence of tokens using a subword tokenizer, transmit the sequence of tokens to a generative neural network model comprising a transformer architecture with self-attention layers, and obtain profile data describing a virtual entity;
classify the profile data into background information, values information, behavioral characteristic information, and purchasing behavior information by applying pattern-based extraction with section markers, and store the classified profile data in a storage device in association with the normalized attribute data;
generate a second prompt based on the classified profile data and target specification data, transmit the second prompt to the generative neural network model, and acquire evaluation output data expressing assessment of the target specification data from a viewpoint of the virtual entity;
aggregate a plurality of pieces of the evaluation output data across a plurality of profile records and compute analysis information including characteristic indices and sentiment scores; and
transmit response data including the classified profile data, the evaluation output data, and the analysis information to the terminal device via the communication interface.

19. The system according to claim 18, wherein the circuitry is further configured to acquire emotion-related data from the terminal device, estimate emotion state information using an emotion estimation model, and integrate the emotion state information with the attribute data when generating the first prompt.

20. A method performed by circuitry of a server coupled to a packet-switched network via a communication interface, the method comprising:
receiving, via the communication interface, attribute data from a terminal device;
normalizing the attribute data by detecting missing or inconsistent items and performing completion or correction based on predefined attribute candidates to obtain normalized attribute data;
generating, by applying the normalized attribute data to a natural language template, a first prompt and transmitting the first prompt to a generative neural network model to obtain profile data generated by the generative neural network model;
classifying the profile data into a plurality of predefined categories and storing the classified profile data in a storage device in association with the normalized attribute data;
generating a second prompt based on at least a portion of the classified profile data, transmitting the second prompt to the generative neural network model, and acquiring evaluation output data from the generative neural network model; and
transmitting response data including the classified profile data and the evaluation output data to the terminal device via the communication interface.
